(19) United States
(12) Patent Application Publication
(10) Pub. No.: US 2010/0215215 A1
(43) Pub. Date: Aug. 26, 2010

(54) OBJECT DETECTING APPARATUS, INTERACTIVE SYSTEM, OBJECT DETECTING METHOD, INTERACTIVE SYSTEM REALIZING METHOD, AND RECORDING MEDIUM

(76) Inventors: Hiromu UESHIMA, Shiga (JP); Kazuo Shimizu, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/638,884

(22) Filed: Dec. 15, 2009

(30) Foreign Application Priority Data
Dec. 18, 2008 (JP) 2008-322922
Dec. 26, 2008 (JP) 2008-334428

(51) Int. Cl. G06K 9/00

(52) U.S. Cl. 382/103

(57) ABSTRACT

This is provided with a plurality of retroreflective sheets each of which is attached to a screen and retroreflectively reflects received light, an imaging unit which photographs the retroreflective sheets, and an MCU which analyzes a differential picture obtained by photographing. The MCU detects, from the differential picture, a shade area corresponding to a part of the retroreflective sheet which is covered by a foot of a player. The detection of the shade area corresponds to the detection of the foot of the player. Because, in the case where the foot is placed on the retroreflective sheet, the part corresponding thereto is not captured in the differential picture, and is present as a shade area. It is possible to detect a foot without attaching and fixing a reflecting sheet to the foot.

### BACKGROUND OF THE INVENTION

1. Field of the Invention

The present invention relates to an object detecting apparatus for analyzing a picture from an imaging device to detect an object, and the related arts.

2. Description of the Related Art

The golf game system by the present applicant is disclosed in Patent Document 1 (Japanese Patent Published Application No. 2004-85524). This golf game system includes a game machine and a golf-club-type input device. A housing of the game machine houses an imaging device. The imaging device comprises an image sensor and infrared light emitting diodes. The infrared light emitting diodes intermittently emit infrared light to a predetermined range upward the imaging device. Accordingly, the image sensor intermittently photographs a reflecting member of the golf-club-type input device which is moving in the range. A position, velocity and the like as input to the game machine can be calculated by processing the stroboscopic images of the reflecting member.

In this prior art, the reflecting member must be fixed or attached to the object to be detected. For example, if the object to be detected is a person, the person has to attach the reflecting member to himself/herself. For this reason, some may feel bothersome due to attach the reflecting member. Particularly, in the case where the object to be detected is a little child, negative situations, e.g., refusing to attach, putting in a mouth, and so on, may occur. Also, loss of the reflecting member, quality deterioration of the reflecting member, and so on may occur.

### SUMMARY OF THE INVENTION

It is therefore an object of the present invention to provide an object detecting apparatus and the related arts capable of detecting an object by a photographing process without attaching and fixing a reflecting member to the object.

In accordance with a first aspect of the present invention, an object detecting apparatus for detecting an object in real space, comprising: a reflective member that is attached to a stationary member, and reflects received light; an imaging unit configured to photograph the reflective member; and an analyzing unit configured to analyze a picture obtained by photographing, wherein the analyzing unit comprising: a detecting unit configured to detect, from the picture, a shade area corresponding to a part of the reflective member which is covered by the object.

In accordance with this configuration, the reflective member attached on the stationary member is photographed, and then the shade area corresponding to the object is detected from the picture thereof. The detection of the shade area corresponds to the detection of the object. Because, in the case where the object is positioned on the reflective member, the part corresponding thereto is not captured in the picture, and is present as a shade area. In this way, it is possible to detect the object by photographing without attaching and fixing a reflective member to the object.

Also, it is possible to detect the movement of the object by detecting the movement of the shade area in the picture. Because, in the case where the object moves from one position on a reflective member to other position on the reflective member, the shade area also moves from a position on the picture corresponding the one position to a position on the picture corresponding the other position, or in the case where the object moves from one reflective member to other reflective member, the shade area also moves from an image of the one reflective member to an image of the other reflective member.

For example, the reflective member has a beltlike shape.

In accordance with this configuration, it is possible to detect the movement of the object in a longitudinal direction of the reflective member. Because, in the case where the object moves from one position of a reflective member to other position of the reflective member, the shade area also moves from a position on the picture corresponding the one position to a position on the picture corresponding the other position.

Also, for example, a plurality of the reflective members is attached to the stationary member, wherein each of the reflective members has a beltlike shape, and wherein the plurality of the reflective members are arranged on the stationary member in a manner parallel to each other.

In accordance with this configuration, it is possible to detect the movement of the object in the longitudinal direction of the reflective member and the movement of the object in a direction perpendicular to the longitudinal direction of the reflective member. Because, in the case where the object moves from one position of a reflective member to other position of the reflective member, the shade area also moves from a position on the picture corresponding the one position to a position on the picture corresponding the other position. Also, in the case where the object moves from one reflective member to other reflective member, the shade area also moves from an image of the one reflective member to an image of the other reflective member.

In this case, as a distance to the imaging unit more increases, widths of the reflective members in a thickness direction are wider.

In accordance with this configuration, even the imaging unit of relatively low-resolution is employed, it is possible to prevent a problem that it is not possible to recognize (capture) the image of the reflective member being arranged at a position where a distance to the imaging unit is larger.

Also, in this case, as a distance to the imaging unit more increases, spacing between the reflective members more increases.

In accordance with this configuration, even the imaging unit of relatively low-resolution is employed, it is possible to prevent a problem that it is not possible to discriminate the images of the two reflective members being arranged at positions where a distance to the imaging unit is larger.

In the above object detecting apparatus, a plurality of the reflective members is attached to the stationary member.

In accordance with this configuration, it is possible to detect the movement of the object to the each reflective member. Also, it is possible to detect the position of the object based on the position of the reflective member as covered.

For example, at least a predetermined number of reflective members of the plurality of the reflective members are two-dimensionally arranged.

In accordance with this configuration, it is possible to detect the position and the movement of the object in the two-dimensional direction.

Also, for example, at least a predetermined number of reflective members of the plurality of the reflective members are one-dimensionally arranged.

In accordance with this configuration, it is possible to detect the position and the movement of the object in the one-dimensional direction.

In the above object detecting apparatus, the plurality of the reflective members includes a reflective member for inputting a predetermined command to a computer by a user.

In accordance with this configuration, the user can input the predetermined command by covering the retroreflective member. Because it is considered that the predetermined command is inputted when it is detected on the picture that the retroreflective member is covered.

In the above object detecting apparatus, the stationary member contains a horizontal plane, wherein the reflective member is attached to the horizontal plane.

In accordance with this configuration, it is possible to easily attach and certainly fix the retroreflective member. Also, it is possible to reduce the processing to the retroreflective member.

In this case, the stationary member is placed on a floor face or is just a floor face.

In accordance with this configuration, for example, in the case where the object is a person, it is suitable for detecting the position and movement of the foot.

The above object detecting apparatus further comprising: an irradiating unit configured to emit light to irradiate the reflective member with the light.

In accordance with this configuration, since the retroreflective member reflects the irradiated light, the retroreflective member is more clearly reflected on the picture, and thereby it is possible to detect the shade area more accurately.

In this object detecting apparatus, the reflective member retroreflectively reflects the received light.

In accordance with this configuration, it is possible to more certainly input the reflected light from the retroreflective member to the imaging unit by arranging the irradiating unit and the imaging unit in nearly the same positions.

In this object detecting apparatus, the irradiating unit intermittently emits the light to irradiate the reflective member with the light, wherein the detecting unit detects the shade area from a differential picture between a picture obtained by photographing when the light is emitted and a picture obtained by photographing when the light is not emitted.

In accordance with this configuration, it is possible to eliminate, as much as possible, noise of light other than the light reflected from the retroreflective member by the simple process of obtaining the difference, and thereby only the image of the retroreflective member can be detected with a high degree of accuracy. To detect the image of the retroreflective member with a high degree of accuracy means that it is possible to detect the shade area with a high degree of accuracy.

In this object detecting apparatus, the irradiating unit emits infrared light, wherein the imaging unit photographs the reflective member via an infrared light filter through which only infrared light passes.

In accordance with this configuration, it is possible to easily eliminate the noise other than the infrared light.

The above object detecting apparatus further comprising: a transparent or semitransparent member that covers the reflective member at least.

In accordance with this configuration, in the where the reflective member is trodden with a foot, it is possible to protect the reflective member and improve durability thereof.

In this case, the transparent and semitransparent members that cover the reflective member include the case where the retroreflective member is coated with transparent or semitransparent material.

In accordance with a second aspect of the present invention, an interactive system comprising: an object detecting unit configured to detect an object in real space; and an information processing unit configured to perform information processing based on result of detection by the object detecting unit, wherein the object detecting unit comprising: a reflective member that is attached to a stationary member, and reflects received light; an imaging unit configured to photograph the reflective member; and an analyzing unit configured to analyze a picture obtained by photographing, wherein the analyzing unit comprising: a detecting unit configured to detect, from the picture, a shade area corresponding to a part of the reflective member which is covered by the object, wherein the information processing unit comprising: an image generating unit configured to generate an image based on the result of the detection by the detecting unit.

In accordance with this configuration, since the same constitution as the object detecting apparatus in accordance with the above first aspect is comprised, the same advantage as that can be gotten. Also, it is possible to show the information to the user (a kind of object) by the video image, detect the user moving according to the showing, and generate the video image based on the result of detecting. That is, it is possible to establish the interactive system. In this case, constitution for detecting the movement of the user is the same as that of the object detecting apparatus in accordance with the above first aspect. Consequently, it is possible to establish the interactive system using the object detecting apparatus in accordance with the above first aspect. Incidentally, in the aspect of the user, to be detected represents to carry out the input.

In this interactive system, the image generating unit generates a plurality of the images in order to display on a plurality of screens.

In accordance with this configuration, since it is possible to simultaneously display the plurality of the video images on the plurality of the screens, entertainment properties can be enhanced.

In this case, the image generating unit coordinates the plurality of the images displayed on the plurality of the screens.

In accordance with this configuration, it is possible to enhance realistic sensation.

In this interactive system, the image generating unit comprising: a unit configured to display a first image of the plurality of the images on a horizontal plane; and a unit configured to display a second image of the plurality of the images on a vertical plane.

In accordance with this configuration, the user (a kind of object) can move the body to input while viewing both of the video image displayed on the horizontal plane and the video image displayed on the vertical plane.

In this interactive system, the stationary member contains a horizontal plane, wherein the reflective member is attached to the horizontal plane.

In accordance with this configuration, it is possible to easily attach and certainly fix the retroreflective member. Also, it is possible to reduce the processing to the retroreflective member.

In this interactive system, the stationary member is placed on a floor face or is just a floor face.

In accordance with this configuration, for example, in the case where the object is a person, it is suitable for detecting the position and movement of the foot, i.e., performing the input by moving the foot.

In accordance with a third aspect of the present invention, an object detecting method for detecting an object in a real space using a reflective member which is attached to a stationary member and reflects received light, comprising the steps of: photographing the reflective member; and analyzing a picture obtained by photographing, wherein the step of analyzing comprising: detecting, from the picture, a shade area corresponding to a part of the reflective member which is covered by the object.

In accordance with this configuration, the same advantage as the object detecting apparatus in accordance with the above first aspect can be gotten.

In accordance with a fourth aspect of the present invention, a method for establishing an interactive system, comprising the steps of: detecting an object in a real space using a reflective member which is attached to a stationary member and reflects received light; and performing information processing based on result of detection by the step of detecting, wherein the step of detecting comprising: photographing the reflective member; and analyzing a picture obtained by photographing, wherein the step of analyzing comprising: detecting, from the picture, a shade area corresponding to a part of the reflective member which is covered by the object, wherein the step of performing the information processing comprising: generating an image based on result of detection by the step of detecting the shade area.

In accordance with this configuration, the same advantage as the interactive system in accordance with the above second aspect can be gotten.

In accordance with a fifth aspect of the present invention, a computer program enables a computer to perform the object detecting method in accordance with the above third aspect.

In accordance with this configuration, the same advantage as the object detecting apparatus in accordance with the above first aspect can be gotten.

In accordance with a sixth aspect of the present invention, a computer program enables a computer to perform the method for establishing the interactive system in accordance with the above fourth aspect.

In accordance with this configuration, the same advantage as the interactive system in accordance with the above second aspect can be gotten.

In accordance with a seventh aspect of the present invention, a computer-readable medium stores the computer program in accordance with the above fifth aspect.

In accordance with this configuration, the same advantage as the object detecting apparatus in accordance with the above first aspect can be gotten.

In accordance with an eighth aspect of the present invention, a computer-readable medium stores the computer program in accordance with the above sixth aspect.

In accordance with this configuration, the same advantage as the interactive system in accordance with the above second aspect can be gotten.

In the present specification and the claims, the computer-readable storage medium includes, for example, a flexible disk, a hard disk, a magnetic tape, a magneto-optical disk, a CD (including CD-ROM, Video-CD), a DVD (including DVD-Video, DVD-ROM, DVD-RAM), a ROM cartridge, a RAM memory cartridge with a battery backup unit, a flash memory cartridge, a nonvolatile RAM cartridge.

The novel features of the invention are set forth in the appended claims. The invention itself, however, as well as other features and advantages thereof, will be best understood by reading the detailed description of specific embodiments in conjunction with the accompanying drawings.

### BRIEF DESCRIPTION OF THE DRAWINGS

FIG. 1 is a diagram showing the entire configuration of an interactive system 1 in accordance with an embodiment of the present invention.

FIG. 2 is a view showing the electric configuration of the interactive system 1 of FIG. 1.

FIG. 3 is an explanatory view for showing the screen 15 of FIG. 1.

FIG. 4 is an explanatory view for showing the scanning of the differential picture 89 at system startup.

FIG. 5 is an explanatory view for showing the scanning of the differential picture 89 during system activation.

FIG. 6A is a view for showing an example of a screen 71T as displayed on the television monitor 5 of FIG. 1 (before answering).

FIG. 6B is a view for showing an example of a screen 71P as projected on the screen 15 of FIG. 1 (before answering).

FIG. 7A is a view for showing an example of a screen 71T as displayed on the television monitor 5 of FIG. 1 (after answering).

FIG. 7B is a view for showing an example of a screen 71P as projected on the screen 15 of FIG. 1 (after answering).

FIG. 8 is a flow chart for showing an example of the photographing process by the MCU 33 of FIG. 2.

FIG. 9 is a flow chart for showing an example of the detecting process by the MCU 33 of FIG. 2 at the system startup.

FIG. 10 is a flow chart for showing an example of the process for detecting the verticality end points in the step S3 of FIG. 9.

FIG. 11 is a flow chart for showing an example of the process for detecting the horizontality end points in the step S5 of FIG. 9.

FIG. 12 is a flow chart for showing an example of the detecting process by the MCU 33 of FIG. 2 during the system activation.

FIG. 13 is a flow chart for showing an example of the kick preprocessing in the step S205 of FIG. 12.

FIG. 14 is a flow chart for showing an example of the process for determining the number of the feet in the step S207 of FIG. 12.

FIG. 15 is a flow chart for showing an example of the process for determining the width in the step S325 of FIG. 14.

FIG. 16 is a flow chart for showing an example of a part of the right-left determining process in the step S209 of FIG. 12.

FIG. 17 is a flow chart for showing an example of the other part of the right-left determining process in the step S209 of FIG. 12.

FIG. 18 is a flow chart for showing an example of the kick determining process in the step S211 of FIG. 12.

FIG. 19 is a flowchart for showing an example of the hit determining process in the step S213 of FIG. 12.

FIG. 20 is a flow chart for showing an example of the command generating process in the step S215 of FIG. 12.

FIG. 21 is a flow chart for showing an example of the processing by the master processor 41 of FIG. 2.

FIG. 22 is a flow chart for showing an example of the processing by the slave processor 45 of FIG. 2.

FIG. 23 is a detailed explanatory view for showing the scanning of the differential picture 89 at the system startup.

FIG. 24 is a detailed explanatory view for showing the scanning of the differential picture 89 during the system activation.

### DESCRIPTION OF THE PREFERRED EMBODIMENTS

In what follows, an embodiment of the present invention will be explained in conjunction with the accompanying drawings. Meanwhile, like references indicate the same or functionally similar elements throughout the drawings, and therefore redundant explanation is not repeated. In the present specification, a suffixed “h” is used to designate a hexadecimal number.

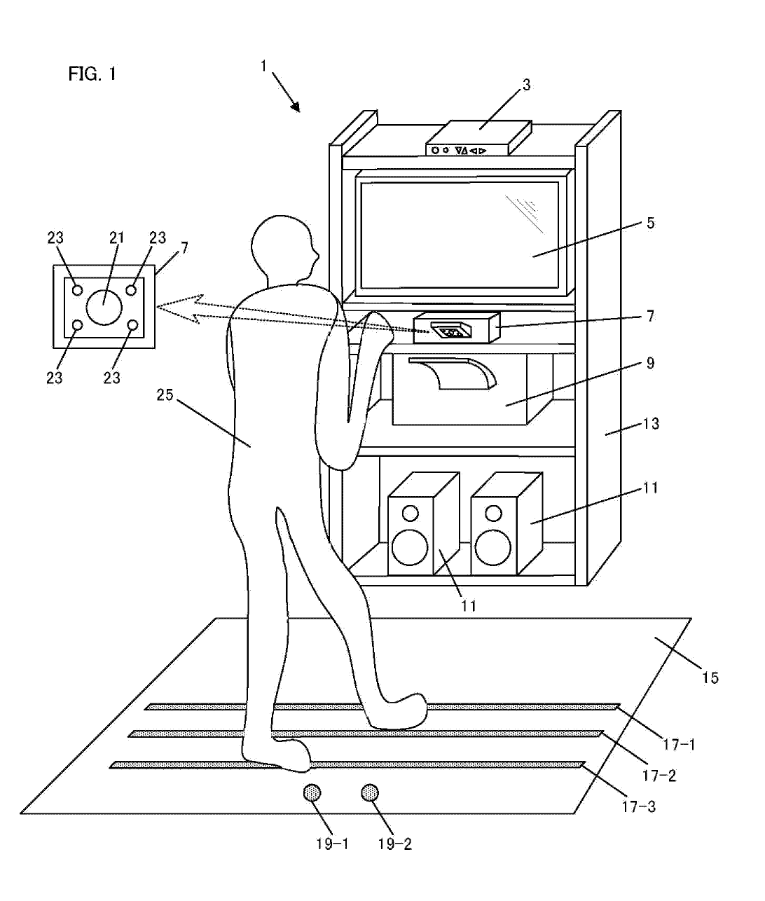

FIG. 1 is a diagram showing the entire configuration of an interactive system 1 in accordance with an embodiment of the present invention. Referring to FIG. 1, this interactive system 1 is provided with a controller 3, a television monitor 5, an imaging unit 7, a projector 9, a speaker 9, and a screen 15. The controller 3, the television monitor 5, the imaging unit 7, the projector 9 and the speaker 11 are respectively arranged at a fifth tier, a fourth tier, a third tier, a second tier, and a first tier of a rack 13 installed on a floor upright. The screen 15 has a rectangular shape, and is fixed on a flat floor in front of the rack 13. A player (an object to be detected) 25 plays on this screen 15.

In the present specification, a side, which is closer to the rack 13, of the screen 15 is referred to as a upper side of the screen 15, and an opposite side thereof is referred to as a lower side of the screen 15. In that case, beltlike retroreflective sheets (retroreflective members) 17-1, 17-2, and 17-3 are fixed in a lower half area of the screen 15 in parallel to one another and in parallel to an upper edge of the screen 15. Also, circular retroreflective sheets (retroreflective members) 19-1 and 19-2 are fixed in the screen 15 along the retroreflective sheet 17-3 between the retroreflective sheet 17-3 and a lower edge of the screen 15. The retroreflective sheets 17-1 to 17-3, 19-1, and 19-2 reflect received light retroreflectively.

Incidentally, since the screen, on which a video image is projected by the projector 9, is imaged by the imaging unit 7, the screen 15 is referred to as a surface to be photographed. Also, although the screen 15 is dedicated, a floor itself may be used as a screen if the floor is flat and it is possible to easily recognize contents of the video image projected thereon. In this case, the floor is a surface to be photographed, and the retroreflective sheets 17-1 to 17-3, 19-1, and 19-2 are fixed on the floor.

Incidentally, the player is an object which moves while the screen 15 is a stationary member because the screen is fixed.

By the way, the controller 3 controls the entire interactive system 1, and further generates a video signal VD1 to be supplied to the television monitor 5, a video signal VD2 to be supplied to the projector 9, and an audio signal (may include voice) AUM to be supplied to the speaker 11. The television monitor 5 displays a video image based on the video signal VD1 generated by the controller 3. The projector 9 projects a video image on the screen 15 based on the video signal VD2 generated by the controller 3.

The imaging unit 7 looks down at the screen 15 and photographs the retroreflective sheets 17-1 to 17-3, 19-1, and 19-2. The imaging unit 7 includes an infrared light filter 12 through which only infrared light is passed, and four infrared light emitting diodes 23 which are arranged around the infrared light filter 21. An image sensor 31 as described below is disposed behind the infrared light filter 21.

The infrared light emitting diodes 23 intermittently irradiates the retroreflective sheets 17-1 to 17-3, 19-1, and 19-2 with the infrared light. The retroreflective sheets 17-1 to 17-3, 19-1, and 19-2 retroreflectively reflect the infrared light as irradiated, and then the reflected infrared light is inputted to the image sensor 31 via the infrared light filter 21. The image sensor 31 a differential picture between a picture when the infrared light is irradiated and a picture when the infrared light is not irradiated. As described below, the controller 3 executes a process of detecting the player 25 based on this differential picture. In this way, the present system 1 includes a detecting apparatus. The controller 3, the imaging unit 7, and the retroreflective sheets 17-1 to 17-3, 19-1, and 19-2 mainly operate as the detecting apparatus.

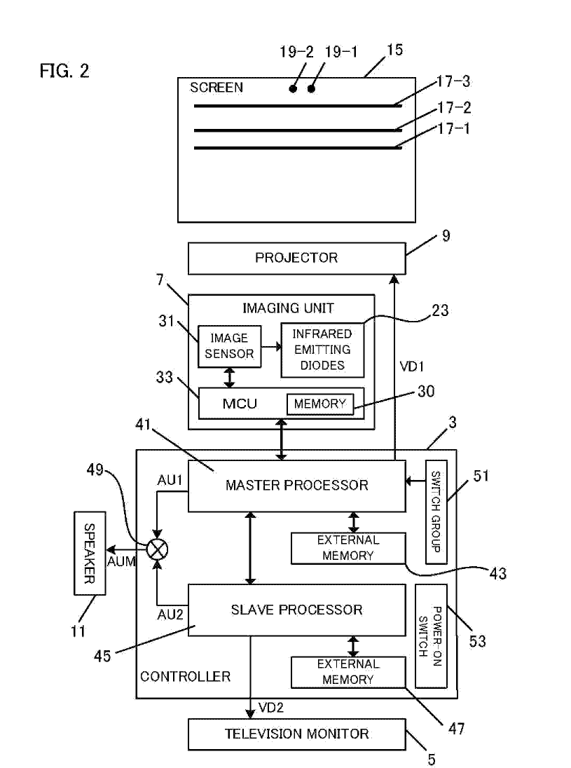

FIG. 2 is a view showing the electric configuration of the interactive system 1 of FIG. 1. Referring to FIG. 2, the controller 3 includes a master processor 41, an external memory 43, a switch group 51, a slave processor 45, an external memory 47, a mixing circuit 49, and a power-on switch 53. The imaging unit 7 includes an MCU (Micro Controller Unit) 33, the image sensor 31, and the infrared light emitting diodes 23.

The master processor 41 is coupled to the external memory 43. The external memory 43, for example, is provided with a flash memory, a ROM, and/or a RAM. The external memory 43 includes a program area, an image data area, and an audio data area. The program area stores control programs for making the master processor 41 execute various processes (e.g., control of the imaging unit 7 and the slave processor 45, receipt of commands and so on from the imaging unit 7, control of images to be supplied to the projector 9, and so on). The image data area stores image data which is required in order to generate the video signal VD1. The audio data area stores audio data which is required in order to generate the audio signal AU1 such as voice, sound effect, and music. The master processor 41 executes the control programs in the program area, reads the image data in the image data area and the audio data in the audio data area, processes them, and generates the video signal (video image) VD1 and the audio signal AU1. The video signal VD1 and the audio signal AU1 are respectively supplied to the projector 9 and the mixing circuit 49.

Although not shown in the figure, the master processor 41 is provided with various function blocks such as a central processing unit (hereinafter referred to as the “CPU”), a graphics processing unit (hereinafter referred to as the “GPU”), a sound processing unit (hereinafter referred to as the “SPU”), a geometry engine (hereinafter referred to as the “GE”), an external interface block, a main RAM, an A/D converter (hereinafter referred to as the “ADC”) and so forth.

The CPU performs various operations and controls the various function blocks in the master processor 41 by executing the programs stored in the external memory 43. The CPU performs the process relating to graphics operations, which are performed by running the program stored in the external memory 43, such as the calculation of the parameters required for the expansion, reduction, rotation and/or parallel displacement of the respective objects and the calculation of eye coordinates (camera coordinates) and view vector. In this description, the term “object” is used to indicate a unit which is composed of one or more polygons or sprites and to which expansion, reduction, rotation and parallel displacement transformations are applied in an integral manner.

The GPU serves to generate a three-dimensional image composed of polygons and sprites on a real time base, and converts it into an analog composite video signal VD1. The SPU generates PCM (pulse code modulation) wave data, amplitude data, and main volume data, and generates an analog audio signal AU1 from them by analog multiplication. The GE performs geometry operations for displaying a three-dimensional image. Specifically, the GE executes arithmetic operations such as matrix multiplications, vector affine transformations, vector orthogonal transformations, perspective projection transformations, the calculations of vertex brightnesses/polygon brightnesses (vector inner products), and polygon back face culling processes (vector cross products).

The external interface block is an interface with peripheral devices (the slave processor 45, MCU 33 and the switch group 51 in the case of the present embodiment) and includes programmable digital input/output (I/O) ports of 24 channels. The ADC is connected to analog input ports of 4 channels and serves to convert an analog signal, which is input from an analog input device (the image sensor 12 in the case of the present embodiment) through the analog input port, into a digital signal. The main RAM is used by the CPU as a work area, a variable storing area, a virtual memory system management area and so forth.

By the way, the switch group 51 includes keys such as arrow keys for performing various operations, and their key statuses are given to the master processor 41. The master processor 41 performs processes in accordance with the received key statuses.

Also, the slave processor 45 is coupled to the external memory 47. The external memory 47, for example, is provided with a flash memory, a ROM, and/or a RAM. The external memory 47 includes a program area, an image data area, and an audio data area. The program area stores control programs for making the slave processor 45 execute various processes (e.g., control of the video image to be displayed on the television monitor 5, and so on). The image data area stores image data which is required in order to generate the video signal VD2. The audio data area stores audio data which is required in order to generate the audio signal AU2 such as sound effect. The slave processor 45 executes the control programs in the program area, reads the image data in the image data area and the audio data in the audio data area, processes them, and generates the video signal (video image) VD2 and the audio signal AU2. The video signal VD2 and the audio signal AU2 are respectively supplied to the television monitor 5 and the mixing circuit 49.

Incidentally, internal configuration of the slave processor 45 is the same as the master processor 41, and therefore the description thereof is omitted.

Also, the master processor 41 and the slave processor 45 communicate with each other, transmit and receive data between each other, and whereby synchronize the video image VD1 to be supplied to the projector 9 and the video image VD2 to be supplied to the television monitor 5, i.e., video contents. In this case, the processor 41 becomes a master to control the processor 45 as a slave.

By the way, the mixing circuit 49 mixes the audio signal AU1 generated by the master processor 41 and the audio signal AU2 generated by the slave processor 45 to output as an audio signal AUM to the speaker 11.

Also, for example, the image sensor 31 of the imaging unit 7 is a CMOS image sensor with 64 times 64 pixels. The image sensor 31 operates under control of MCU 33. The particularity is as follows. The image sensor 31 drives the infrared light emitting diodes 23 intermittently. Accordingly, the infrared light emitting diodes 23 emit the infrared light intermittently. As the result, the retroreflective sheets 17-1 to 17-3, 19-1, and 19-2 are intermittently irradiated with the infrared light. The image sensor 31 photographs the retroreflective sheets 17-1 to 17-3, 19-1, and 19-2 at the respective times when the infrared light is emitted and when the infrared light is not emitted. Then, the image sensor 31 generates the differential picture signal between the picture signal at the time when the infrared light is emitted and the picture signal at the time when the infrared light is not emitted to output the MCU 33. It is possible to eliminate, as much as possible, noise of light other than the light reflected from the retroreflective sheets 17-1 to 17-3, 19-1, and 19-2 by obtaining the differential picture signal, so that the retroreflective sheets 17-1 to 17-3, 19-1, and 19-2 can be detected with a high degree of accuracy. That is, since the retroreflective sheets 17-1 to 17-3, 19-1, and 19-2 reflect the infrared light retroreflectively, the images thereof are reflected as images with the higher luminance in comparison with the background into the photographed image at the light emitting period. On the other hand, since the retroreflective sheets 17-1 to 17-3, 19-1, and 19-2 are not irradiated with the infrared light at the non-light emitting period, the images thereof are reflected as images with the lower luminance as well as the background into the photographed image. As the result, only the images of the retroreflective sheets 17-1 to 17-3, 19-1, and 19-2 can be extracted by generating the differential picture.

The MCU 33 has a memory 30, and executes control programs stored in the memory 30 to perform processes shown in flowcharts as described below. That is, the MCU 33 binarizes the differential picture from the image sensor 31 with a predetermined threshold value, analyzes the binarized differential picture to detect the player 25, and then transmits commands and coordinates (discussed later) to the master processor 41. The master processor 41 controls the video image to give to the projector 9, the sound to give to the speaker 11, and the slave processor 45, on the basis of the commands and the coordinates received from the MCU 33. These processes will be described in detail below.

The projector 9 projects the video image based on the video signal VD1 given from the master processor 41 on the screen 15. The television monitor 5 displays the video image based on the video signal VD2 given from the slave processor 45. The speaker 11 outputs the sound based on the audio signal AUM given from the mixing circuit 49.

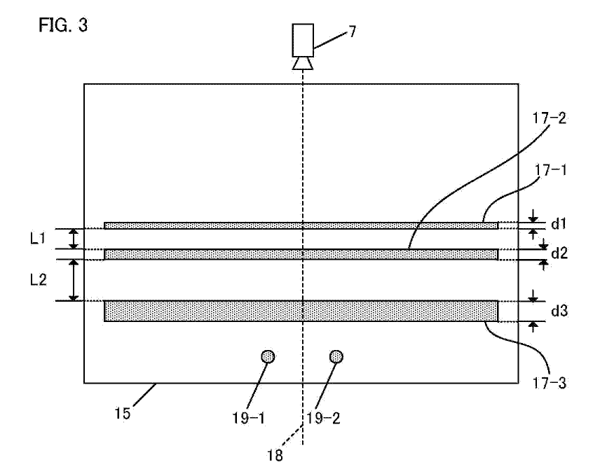

FIG. 3 is an explanatory view for showing the screen 15 FIG. 1. Referring to FIG. 3, relation among a width d1 of the retroreflective sheet 17-1, a width d2 of the retroreflective sheet 17-2, and a width d3 of the retroreflective sheet 17-3 on the screen 15 is d1<d2<d3. In this way, as the distance to the imaging unit 7 (the image sensor 31) more increases, the widths of the beltlike retroreflective sheet are wider. Also, relation between a distance L1 and a distance L2 is L1<L2. The distance L1 is a distance between the retroreflective sheet 17-1 and the retroreflective sheet 17-2. The distance L2 is a distance between the retroreflective sheet 17-2 and the retroreflective sheet 17-3. In this way, the distance to the imaging unit 7 (image sensor 31) more increases, spacing between the retroreflective sheets more increases. These reasons are as follows.

First, an axis 18, which is obtained by orthographically projecting an optical axis of the image sensor 31 of the imaging unit 7 onto the screen 15, is assumed because of convenience of explanation. In this case, the retroreflective sheets 17-1 to 17-3 are arranged so as to perpendicularly intersect this axis 18. Also, a line segment D, which has a certain length along the axis 18 on the screen 15, is assumed.

The image sensor 31 of the imaging unit 7 looks down at the screen 15. Accordingly, the differential picture from the image sensor 31 has a trapezoidal distortion. That is, the rectangular screen 15 is reflected as a trapezoidal image into the differential picture. In this case, a distance to the image sensor 31 more increases, the trapezoidal distortion becomes larger. Accordingly, a length of the image of the line segment D located at the upper side of the screen 15 (on the side closer to the image sensor 31) in the differential picture is larger than a length of the image of the line segment D located at the lower side of the screen 15 (on the side farther from the image sensor 31) in the differential picture.

For this reason, if the retroreflective sheets 17-1 to 17-3 are arranged at even intervals (L1=L2), in the differential picture, the distance between the image of the retroreflective sheet 17-2 and the image of the retroreflective sheet 17-3 becomes shorter than the distance between the image of the retroreflective sheet 17-1 and the image of the retroreflective sheet 17-2. In the case where the image sensor 31 of relatively low-resolution (e.g., 64 times 64 pixels) is employed, particularly, it may occur that an image of the retroreflective sheet 17-2 can not be distinguished from an image of the retroreflective sheet 17-3. Accordingly, even if the low-resolution image sensor 31 is employed, it is possible to certainly distinguish the image of the retroreflective sheet 17-2 from the image of the retroreflective sheet 17-3 in the differential picture by satisfying the distances L1<L2.

By the same token, if the widths of the retroreflective sheets 17-1 to 17-3 are equal to one another (d1=d2=d3), the width of the image of the retroreflective sheet 17-3 is less than the width of the retroreflective sheet 17-2 while the width of the image of the retroreflective sheet 17-2 is less than the width of the retroreflective sheet 17-1, in the differential picture by the trapezoidal distortion. Thus, in the case where the image sensor 31 of relatively low-resolution (e.g., 64 times 64 pixels) is employed, particularly, it may occur that the image of the retroreflective sheet 17-3 can not be recognized (captured). Accordingly, even if the low-resolution image sensor 31 is employed, it is possible to certainly recognize the image of the retroreflective sheet 17-3 in the differential picture by satisfying the widths d3>d2>d1 on the screen 15. Also, although it is not required that the width of the retroreflective sheet 17-2 is as wide as the retroreflective sheet 17-3, the width of the retroreflective sheet 17-2 is wider than the width of the retroreflective sheet 17-1 (d2>d1), and thereby certainty of the recognition is improved.

Next, a method for detecting the player 25 by the MCU 33 of the imaging unit 7 will be described. Processing at system startup is firstly described, followed by processing during system activation. Also, in the description, it is assumed that the differential picture is a binarized differential picture.

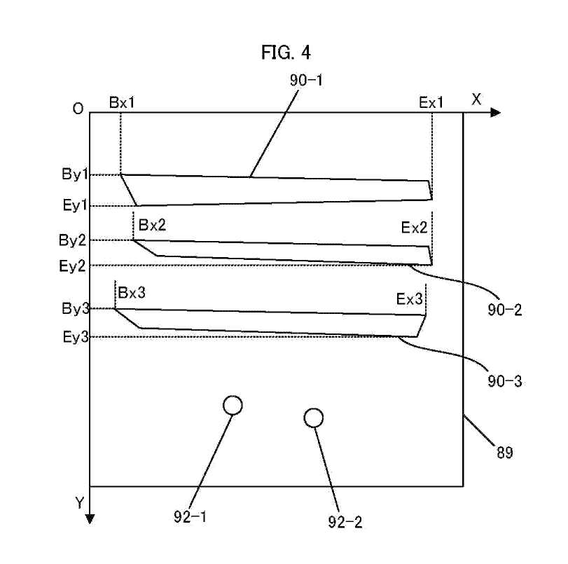

FIG. 4 is an explanatory view for showing the scanning of the differential picture 89 at system startup. Referring to FIG. 4, the origin is set to the upper left corner of the differential picture 89 generated by the image sensor 31 with the positive X-axis extending in the horizontal right direction and the positive Y-axis extending in the vertical down direction. The images 90-1, 90-2, 90-3, 92-1 and 92-2, which correspond to the retroreflective sheets 17-1, 17-2, 17-3, 19-1 and 19-2 respectively, are reflected in this differential picture 89.

When the power-on switch 53 is turned on, the MCU 33 of the imaging unit 7 instructs the image sensor 31 to photograph in response to the command of the master processor 41. The image sensor starts the photographing process in response to this photographing instruction. This photographing process includes driving the infrared emitting diodes 23 intermittently, photographing at light emitting time and at non-light emitting time respectively, and generating the differential picture between the picture at the light emitting time and the picture at the non-light emitting time. The MCU 33 analyzes the differential picture to transmit the result of the analysis (commands and coordinates) to the master processor 41.

As shown in FIG. 4, particularly, at power-up (at the system startup), the MCU 33 scans the differential picture 89 in response to the command from the master processor 41, detects a minimum X coordinate Bx1 and a maximum X coordinate Ex1 of the image 90-1, a minimum X coordinate Bx2 and a maximum X coordinate Ex2 of the image 90-2, and a minimum X coordinate Bx3 and a maximum X coordinate Ex3 of the image 90-3, and then stores them in the internal memory thereof.

This is for the following reason. The player 25 may tread upon the left end or the right end of the retroreflective sheet 17-1 during playing. This is also true regarding the retroreflective sheets 17-2 and 17-3. Accordingly, when the player 25 does not stand on the screen 15 at the system startup, the left ends (referential-left end) and the right ends (referential-right end) of the respective images 90-1 to 90-3 of the respective retroreflective sheets 17-1 to 17-3 are preliminarily detected. Then, it is determined whether or not the player 25 treads upon the left end by comparing the left end of each image 90-1 to 90-3 during playing with the corresponding referential-left end. Also, it is determined whether or not the player 25 treads upon the right end by comparing the right end of each image 90-1 to 90-3 during playing with the corresponding referential-right end.

Also, at power-up (at the system startup), the MCU 33 may scan the differential picture 89 in response to the command from the master processor 41, detect a minimum Y coordinate By1 and a maximum Y coordinate Ey1 of the image 90-1, a minimum Y coordinate By2 and a maximum Y coordinate Ey2 of the image 90-2, and a minimum Y coordinate By3 and a maximum Y coordinate Ey3 of the image 90-3, and then store them in the internal memory thereof.

Incidentally, a rectangle, which is defined by the minimum X coordinate Bx1, the maximum X coordinate Ex1, the minimum Y coordinate By1, and the maximum Y coordinate Ey1 of the image 90-1 of the retroreflective sheet 17-1, is referred to as a rectangular area #1. A rectangle, which is defined by the minimum X coordinate Bx2, the maximum X coordinate Ext, the minimum Y coordinate By2, and the maximum Y coordinate Ey2 of the image 90-2 of the retroreflective sheet 17-2, is referred to as a rectangular area #2. A rectangle, which is defined by the minimum X coordinate Bx3, the maximum. X coordinate Ex3, the minimum Y coordinate By3, and the maximum Y coordinate Ey3 of the image 90-3 of the retroreflective sheet 17-3, is referred to as a rectangular area #3. It is assumed that the images 92-1 and 92-2 corresponding to the retroreflective sheets 19-1 and 19-2 are a single image 90-4 as a whole, and a rectangle, which is defined by the minimum X coordinate, the maximum X coordinate, the minimum Y coordinate, and the maximum Y coordinate of the image 90-4, is referred to as a rectangular area #4.

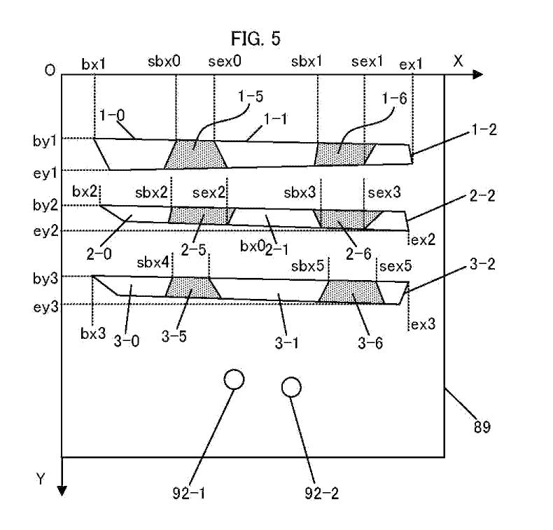

FIG. 5 is an explanatory view for showing the scanning of the differential picture 89 during system activation. Referring to FIG. 5, this differential picture 89 is obtained by the photographing process when the player 25 stands on (treads upon) the retroreflective sheet 17-1 with both the feet. Accordingly, the differential picture 89 contains the images 1-0, 1-1, 1-2, 2-0, 2-1, 2-2, 3-0, 3-1, 3-2, 92-1, and 92-2. Although areas (hereinafter referred to as “shade areas”) 1-5, 1-6, 2-5, 2-6, 3-5 and 3-6 are designated by hatching because of convenience of explanation, they are parts where images do not exist actually.

The images 1-0, 1-1 and 1-2 are the image of the retroreflective sheet 17-1. Since both the feet of the player 25 are placed on the retroreflective sheet 17-1, the retroreflective sheet 17-1 is partially hidden behind, and therefore only parts of the retroreflective sheet 17-1, which are not hidden behind, are reflected in the differential picture 89. The shade area 1-5 corresponds to apart where the left foot of the player 25 is placed while the shade area 1-6 corresponds to a part where the right foot of the player 25 is placed. That is, the shade area 1-5 corresponds to the left foot of the player 25 while the shade area 1-6 corresponds to the right foot of the player 25. In this way, the shade areas 1-5 and 1-6 designate positions of both the feet of the player 25.

The images 2-0, 2-1 and 2-2 are the image of the retroreflective sheet 17-2. Since both the feet of the player 25 are placed on the retroreflective sheet 17-1, parts of the retroreflective sheet 17-2, which are hidden behind both the feet, are not reflected in the differential picture 89, and therefore only parts of the retroreflective sheet 17-2, which are not hidden behind, are reflected in the differential picture 89. The shade area 2-5 corresponds to a part where is a shade of the left foot of the player 25 while the shade area 2-6 corresponds to a part where is a shade of the right foot of the player 25.

The images 3-0, 3-1 and 3-2 are the image of the retroreflective sheet 17-3. Since both the feet of the player 25 are placed on the retroreflective sheet 17-1, parts of the retroreflective sheet 17-3, which are hidden behind both the feet, are not reflected in the differential picture 89, and therefore only parts of the retroreflective sheet 17-3, which are not hidden behind, are reflected in the differential picture 89. The shade area 3-5 corresponds to a part where is a shade of the left foot of the player 25 while the shade area 3-6 corresponds to a part where is a shade of the right foot of the player 25.

Incidentally, in this example, it is assumed that the images 1-0, 1-1 and 1-2 corresponding to the retroreflective sheet 17-1 are a single image as a whole, and a rectangular area #1 is defined by the minimum X coordinate bx1, the maximum X coordinate ex1, the minimum Y coordinate by1, and the maximum Y coordinate ey1. It is assumed that the images 2-0, 2-1 and 2-2 corresponding to the retroreflective sheet 17-2 are a single image as a whole, and a rectangular area #2 is defined by the minimum. X coordinate bx2, the maximum X coordinate ex2, the minimum Y coordinate by2, and the maximum Y coordinate ey2. It is assumed that the images 3-0, 3-1 and 3-2 corresponding to the retroreflective sheet 17-3 are a single image as a whole, and a rectangular area #3 is defined by the minimum X coordinate bx3, the maximum X coordinate ex3, the minimum Y coordinate by3, and the maximum Y coordinate ey3. A rectangular are area #4 is the same as that at system startup.

By the way, the MCU 33 of the imaging unit 7 executes the following process during the system activation, i.e., during playing.

The MCU 33 scans the rectangular area #1 to detect the shade areas 1-5 and 1-6. Specifically, the MCU 33 detects an X coordinates (referred to as “adjacency X coordinates”), each of which is an X coordinate of a pixel which has the luminance value “0” and is next to a pixel with the luminance value “1”, in the rectangular area (bx1≦X≦ex1, by1≦Y≦ey1), and stores each of the adjacency X coordinates, i.e., X coordinates sbx0, sex0, sbx1 and sex1 in the internal memory if the adjacency X coordinate satisfies condition that the luminance values of all the pixels, whose X coordinates are the same as the adjacency X coordinate, are “0” in the rectangular area (by1≦Y≦ey1). In this case, the pixel with the luminance value “1” is a part of an image as captured while the pixel with the luminance value “0” is not the part of the image and is a part in which nothing is captured.

In a similar manner, the MCU 33 scans the rectangular area 42, detects the shade areas 2-5 and 2-6, i.e., the X coordinates sbx2, sex2, sbx3 and sex3, and then stores them in the internal memory. Also, in a similar manner, the MCU 33 scans the rectangular area #3, detects the shade areas 3-5 and 3-6, i.e., the X coordinates sbx4, sex4, sbx5 and sex5, and then stores them in the internal memory.

Further, the MCU 33 calculates the coordinates (X15, Y15) of the shade area 1-5, the coordinates (X16, Y16) of the shade area 1-6, the coordinates (X25, Y25) of the shade area 2-5, the coordinates (X26, Y26) of the shade area 2-6, the coordinates (X35, Y35) of the shade area 3-5, and the coordinates (X36, Y36) of the shade area 3-6 based on the following formulae, and then stores them in the internal memory.

X15=(sbx0+sex0)/2

Y15=(by1+ey1)/2

X16=(sbx1+sex1)/2

Y16=(by1+ey1)/2

X25=(sbx2+sex2)/2

Y25=(by2+ey2)/2

X26=(sbx3+sex3)/2

Y26=(by2+ey2)/2

X35=(sbx4+sex4)/2

Y35=(by3+ey3)/2

X36=(sbx5+sex5)/2

Y36=(by3+ey3)/2

Further, the MCU 33 determines whether or not the two shade areas 1-5 and 1-6 are present in the rectangular area #1. Then, when the two shade areas 1-5 and 1-6 are present, the MCU 33 determines that the shade area 1-5 corresponds to the left foot of the player 25 while the shade area 1-6 corresponds to the right foot of the player 25, and then stores the result in the internal memory.

The MCU 33 performs the first right-left determining process to be hereinafter described if it is determined that only the single shade area is present in the rectangular area #1.

Also, when the MCU 33 determines that two shade areas 1-5 and 1-6 are not present, the MCU 33 determines whether or not the two shade areas 2-5 and 2-6 are present in the rectangular area #2. Then, when the two shade areas 2-5 and 2-6 are present, the MCU 33 determines that the shade area 2-5 corresponds to the left foot of the player 25 while the shade area 2-6 corresponds to the right foot of the player 25, and then stores the result in the internal memory.

The MCU 33 performs the first right-left determining process to be hereinafter described if it is determined that only the single shade area is present in the rectangular area #2.

Also, when the MCU 33 determines that the two shade areas 2-5 and 2-6 are not present, the MCU 33 determines whether or not the two shade areas 3-5 and 3-6 are present in the rectangular area #3. Then, when the two shade areas 3-5 and 3-6 are present, the MCU 33 determines that the shade area 3-5 corresponds to the left foot of the player 25 while the shade area 3-6 corresponds to the right foot of the player 25, and then stores the result in the internal memory.

Further, when the MCU 33 determines that only the single shade area is present in the rectangular area #1, only the single shade area is present in the rectangular area #2, and only the single shade area is present in the rectangular area #3, when the MCU 33 determines that the shade area is not present in the rectangular area #1, only the single shade area is present in the rectangular area #2, and only the single shade area is present in the rectangular area #3, or when the MCU 33 determines that the shade area is not present in the rectangular area #1, the shade area is not present in the rectangular area #2, and only the single shade area is present in the rectangular area #3, the MCU 33 performs the second right-left determining process to be hereinafter described.

The above first right-left determining process will be described. In the case where the MCU 33 determines that only a single shade area is present in the rectangular area #1, if an X coordinate of the shade area is closer to the X coordinate X25 of the shade area 2-5 than the X coordinate X26 of the shade area 2-6, the MCU 33 regards the shade area of the rectangular area #1 as the shade area 1-5, determines that it corresponds to the left foot of the player 25 while the shade area 2-6 corresponds to the right foot of the player 25, and then stores the result of the determination in the internal memory. On the other hand, if an X coordinate of a shade area of the rectangular area #1 is closer to the X coordinate X26 of the shade area 2-6 than the X coordinate X25 of the shade area 2-5, the MCU 33 regards the shade area of the rectangular area #1 as the shade area 1-6, determines that it corresponds to the right foot of the player 25 while the shade area 2-5 corresponds to the left foot of the player 25, and then stores the result of the determination in the internal memory.

Also, in the case where the MCU 33 determines that only a single shade area is present in the rectangular area #2, if an X coordinate of the shade area is closer to the X coordinate X35 of the shade area 3-5 than the X coordinate X36 of the shade area 3-6, the MCU 33 regards the shade area of the rectangular area #2 as the shade area 2-5, determines that it corresponds to the left foot of the player 25 while the shade area 3-6 corresponds to the right foot of the player 25, and then stores the result of the determination in the internal memory. On the other hand, if an X coordinate of a shade area of the rectangular area #2 is closer to the X coordinate X36 of the shade area 3-6 than the X coordinate X35 of the shade area 3-5, the MCU 33 regards the shade area of the rectangular area #2 as the shade area 2-6, determines that it corresponds to the right foot of the player 25 while the shade area 3-5 corresponds to the left foot of the player 25, and then stores the result of the determination in the internal memory.

The above second right-left determining process will be described. When the MCU 33 determines that only a single shade area is preset in the rectangular area #1, only a single shade area is preset in the rectangular area #2, and only a single shade area is preset in the rectangular area #3, the MCU 33 compares a length “A” (is either (sex0-sbx0) or (sex1-sbx1), but it is unclear in this stage which it is.) of the shade area of the rectangular area #1 in the X direction with a length “B” (is either (sex2-sbx2) or (sex3-sbx3), but it is unclear in this stage which it is.) of the shade area of the rectangular area #2 in the X direction. Then, if the value “B” is larger than the value (2*A), the MCU 33 determines that the one foot of the player 25 is placed on the retroreflective sheet 17-1 while the other foot of the player 25 is placed on the retroreflective sheet 17-2 (Right and left are unclear in this stage.).

Then, the MCU 33 divides the shade area of the rectangular area #2 in two by a line parallel to the Y axis (i.e., a straight line whose X coordinate is invariably equal to the X coordinate of the shade area) to calculate X coordinates of the respective areas as obtained (referred to as a left area and a right area). Specifically, the MCU 33 calculates an average value of the X coordinate of the shade area of the rectangular area #2 and the X coordinate (is either sbx2 or sbx3, but it is unclear in this stage which it is.) of the left end of the shade area, and then sets an X coordinate of the left area to the average value. Also, the MCU 33 calculates an average value of the X coordinate of the shade area of the rectangular area #2 and the X coordinate (is either sex2 or sex3, but it is unclear in this stage which it is.) of the right end of the shade area, and then sets an X coordinate of the right area to the average value.

Then, if the X coordinate of the shade area of the rectangular area #1 is closer to the X coordinate of the left area than the X coordinate of the right area, the MCU 33 regards the shade area of the rectangular area #1 as the area 1-5, determines that it corresponds to the left foot of the player 25 while the shade area of the rectangular area #2 corresponds to the right foot of the player, and then stores the result of the determination in the internal memory. On the other hand, if the X coordinate of the shade area of the rectangular area #1 is closer to the X coordinate of the right area than the X coordinate of the left area, the MCU 33 regards the shade area of the rectangular area #1 as the area 1-6, determines that it corresponds to the right foot of the player 25 while the shade area of the rectangular area #2 corresponds to the left foot of the player, and then stores the result of the determination in the internal memory.

Also, if the value “B” is equal to the value (2*A) or less, the MCU 33 determines that the right and left are indefinite, and then stores the result of the determination in the internal memory.

Further, when the MCU 33 determines that the shade area is not preset in the rectangular area #1, only a single shade area is preset in the rectangular area #2, and only a single shade area is preset in the rectangular area #3, the MCU 33 determines the right and left, or indefiniteness in a manner similar to the above mention. Also, when the MCU 33 determines that the shade area is not preset in the rectangular area #1, the shade area is not preset in the rectangular area #2, and only a single shade area is preset in the rectangular area #3, the MCU 33 determines the indefiniteness.

By the way, the master processor 41 updates a video image in synchronization with a video synchronization signal. For example, the video synchronization signal is generated at 1/60 second intervals. A period from the generation of the video synchronization signal to the generation of the next video synchronization signal is referred as a flame period. These are also true regarding the slave processor 45.

The master processor 41 transmits a request signal to the MCCU 33 every time the video synchronization signal is generated. The MCU 33 instructs the imaging unit 7 to photograph and performs the above various processes in response to this request signal. Accordingly, the MCU 33 completes the photographing process and the above various processes within one frame period, and waits for the next request signal.

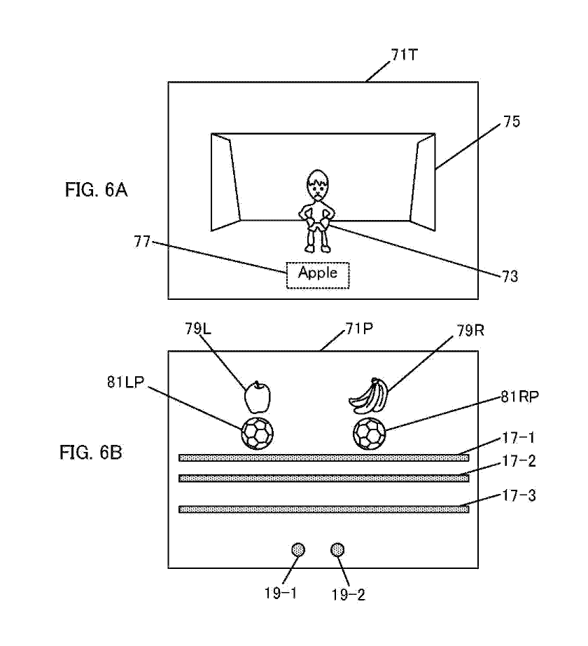

By the way, although contents of a game to be displayed on the screen 15 and the television monitor 5 are below described in detail, parts related to the following mention will be described. As shown in FIG. 6B to be described below, two ball objects 81LP and 81RP are projected on the screen 15. In this case, an X coordinate (referred to as a left-ball left-end X coordinate) in the differential picture 89 and an X coordinate (referred to as a left-ball right-end X coordinate) in the differential picture 89 are preliminarily calculated to store them in the memory 30. The left-ball left-end X coordinate corresponds to the foot of a perpendicular drawn from the left end of the ball object 81LP as projected to the retroreflective sheet 17-1. The left-ball right-end X coordinate corresponds to the foot of a perpendicular drawn from the right end of the ball object 81LP as projected to the retroreflective sheet 17-1. Likewise, an X coordinate (referred to as a right-ball left-end X coordinate) in the differential picture 89 and an X coordinate (referred to as a right-ball right-end X coordinate) in the differential picture 89 are preliminarily calculated to store them in the memory 30. The right-ball left-end X coordinate corresponds to the foot of a perpendicular drawn from the left end of the ball object 81RP as projected to the retroreflective sheet 17-1. The right-ball right-end X coordinate corresponds to the foot of a perpendicular drawn from the right end of the ball object 81RP as projected to the retroreflective sheet 17-1.

Meanwhile, the MCU 33 determines whether or not the player 25 has performed a kick motion for the ball object projected on the screen 15. The particularity is as follows. The MCU 33 turns on a first kick flag stored in the internal memory when both the images 92-1 and 92-2 corresponding to the retroreflective sheets 19-1 and 19-2 are not detected and the shade area is not detected in all the rectangular areas #1 to #3 in the differential picture 89.

The MCU 33 determines that the player 25 places the left foot and the right foot on the retroreflective sheets 19-1 and 19-2 respectively if the first kick flag is turned on, and determines that the player 25 has completed the preparation. Because the images 92-1 and 92-2 are not contained in the differential picture 89 if the retroreflective sheets 19-1 and 19-2 are covered by the left foot and right foot. However, even both the feet of the player 25 are placed on any one of the retroreflective sheet 17-1, 17-2, and 17-3, the retroreflective sheets 19-1 and 19-2 are shaded, and therefore there may be a occasion when the images 92-1 and 92-2 are not contained. Thus, it is required that the shade area is not contained in any one of the rectangular areas #1 to #3, i.e., the player 25 does not place the feet on any of the retroreflective sheets 17-1, 17-2 and 17-3, as one of conditions for turning on the first kick flag.

In this way, the retroreflective sheets 19-1 and 19-2 are used in order to communicate the completion of the preparation of the player 25 to the controller 3. Thus, it can be said that the retroreflective sheets 19-1 and 19-2 are retroreflective sheets for inputting a command to the controller 3 by the player 25.

Also, the MCU 33 turns on a second kick flag store in the internal memory if it is determined that at least one shade area is present in the differential picture 89 after turning the first kick flag on.

Further, the MCU 33 determines whether or not both the feet of the player 25 are placed on the retroreflective sheet 17-2, i.e., the two shade areas (2-5 and 2-6) are present in the rectangular area #2 in the differential picture 89. Then, the MCU 33 turns on a third kick flag if it is determined that the two shade areas are present in the rectangular area #2.

Then, further, the MCU 33 turns on a fourth kick flag if it is determined that a state transits from a state where the two shade areas are not present to a state where the one shade area is present in the rectangular area #1 under a condition that the third kick flag is being turned on (referred to as a “first pattern kick”). That is, the MCU 33 turns the fourth kick flag on if it is determined that a state transits from a state where both the feet are placed on the retroreflective sheet 17-2 to a state where any one of the feet is placed on the retroreflective sheet 17-1.

Also, the MCU 33 turns on the fourth kick flag if it is determined that a state transits from a state where the one shade area is present to a state where the two shade areas are present in the rectangular area #1 under a condition that the third kick flag is being turned on (referred to as a “second pattern kick”). That is, the MCU 33 turns the fourth kick flag on if it is determined that a state transits from a state where any one of the feet is placed on the retroreflective sheet 17-1 to a state where the other foot is also placed on the retroreflective sheet 17-1.

Further, the MCU 33 turns the fourth kick flag on if it is determined that a state transits from a state where the shade area is not present to a state where the two shade areas are present in the rectangular area #1 under a condition that the third kick flag is being turned on (referred to as a “third pattern kick”). That is, the MCU 33 turns the fourth kick flag on if it is determined that a state transits from a state where both the feet are placed on the retroreflective sheet 17-2 to a state where both the feet are placed on the retroreflective sheet 17-1.

Further, in the case where the shade area is not present in the rectangular area #1, the MCU 33 turns the fourth kick flag on if it is determined that a state transits from a state where the one shade area is present to a state where the two shade areas are present in the rectangular area #2 under a condition that the third kick flag is being turned on (referred to as a “fourth pattern kick”). That is, the MCU 33 turns the fourth kick flag on if it is determined that a state transits from a state where the one foot is placed on the retroreflective sheet 17-2 to a state where both the feet are placed on the retroreflective sheet 17-2.

After turning on the fourth kick flag, the MCU 33 performs a process relating to a fifth kick flag. The particularity is as follows. The MCU 33 determines whether or not the player 25 has performed the kick motion for the ball object projected on the screen 15 based on an X coordinate of the top shade area (referred to as a top-left shade area) of the left shade areas and an X coordinate of the top shade area (referred to as a top-right shade area) of the right shade areas. In this case, the term “top left” indicates the shade area with the minimum Y coordinate among the left shade areas (in the example of FIG. 5, the shade area 1-5 with the minimum Y coordinate among the left shade areas 1-5, 2-5, and 3-5), and the term “top right” indicates the shade area with the minimum Y coordinate among the right shade areas (in the example of FIG. 5, the shade area 1-6 with the minimum Y coordinate among the right shade areas 1-6, 2-6, and 3-6).

That is, the MCU 33 determines that the player 25 appropriately has performed the kick motion for the ball object 81LP if the X coordinate of the top-left shade area is positioned between the left-ball left-end X coordinate and the left-ball right-end X coordinate (referred to as a “left kick range”), and then sets the fifth kick flag to “01h” which indicates that the ball object 81LP has been kicked. Also, even the X coordinate of the top-left shade area is not present within the left kick range, the MCU 33 determines that the player 25 appropriately has performed the kick motion for the ball object 81LP if the X coordinate of the top-right shade area is present within the left kick range, and then sets the fifth kick flag to “01h”.

Further, the MCU 33 determines that the player 25 appropriately has performed the kick motion for the ball object 81RP if the X coordinate of the top-left shade area is positioned between the right-ball left-end X coordinate and the right-ball right-end X coordinate (referred to as a “right kick range”), and then sets the fifth kick flag to “10h” which indicates that the ball object 81RP has been kicked. Still further, even the X coordinate of the top-left shade area is not present within the right kick range, the MCU 33 determines that the player 25 appropriately has performed the kick motion for the ball object 81RP if the X coordinate of the top-right shade area is present within the right kick range, and then sets the fifth kick flag to “10h”.

Still further, when none of the X coordinate of the top-left shade area and the X coordinate of the top-right shade area are present within the left hit range and within the right hit range, the MCU 33 sets the fifth kick flag to “00h” which indicates that the ball objects 81LP and 81RP has not been kicked.

By the way, the MCU 33 outputs a signal (referred to as a “first command”) which indicates that the first kick flag is turned on, a signal (referred to as a “second command”) which indicates that either the second or third kick flag is turned on, a signal (referred to as a “third command”) which indicates that the fifth kick flag is turned on (either 01h or 10h), or a signal (a zeroth command) which indicates that a case does not conform to either one of them, to the master processor 41 in the response to the above request signal from the master processor 41.

Incidentally, when the MCU 33 transmits the second command and/or third command, the MCU 33 appends the XY coordinates of the top-left shade area and the XY coordinates of the top-right shade area to the command to transmit them.

By the way, next, contents of a game to be displayed on the screen 15 and the television monitor 5 will be described.

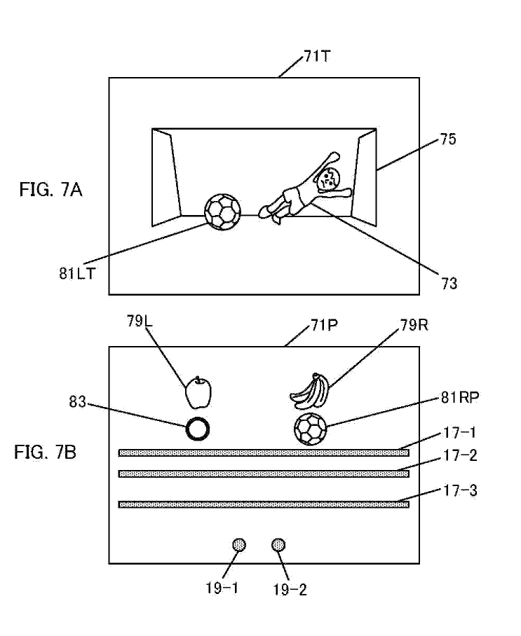

FIG. 6A is a view for showing an example of a screen 71T as displayed on the television monitor 5 of FIG. 1 (before answering). FIG. 6B is a view for showing an example of a screen 71P as projected on the screen 15 of FIG. 1 (before answering). FIG. 7A is a view for showing an example of a screen 71T as displayed on the television monitor 5 of FIG. 1 (after answering). FIG. 7B is a view for showing an example of a screen 71P as projected on the screen 15 of FIG. 1 (after answering).

Referring to FIG. 6B, when the master processor 41 receives the first command from the MCU 33, the master processor 41 generates the video signal VD1 for expressing to the screen 71P to supply the projector 9 with it. Then, the projector 9 projects a video image of the screen 71P on the screen 15 based on the video signal VD1. This screen 71P contains question objects 79L and 79R, and the ball objects 81LP and 81RP.

The ball objects 81LP and 81RP are arranged in the screen 71P so that they are arranged along the retroreflective sheet 17-1 and separates from each other by a predetermined distance. Also, the question object 79L is arranged right above the ball object 81LP. The question object 79R is arranged right above the ball object 81RP.

Referring to FIG. 6A, when the master processor 41 receives the first command from the MCU 33, the master processor 41 instructs the slave processor 45 to generate the screen 71T. The slave processor 45 generates the video signal VD2 for expressing the screen 71T in response to this generation instruction, and then supplies the television monitor 5 with it. Then, the television monitor 5 displays the video image of the screen 71T based on the video signal VD2. This screen 71T contains a goalkeeper object 73, a goal object 75 and a question area 77. The slave processor 45 displays an English word as selected in a random manner from a question table in the question area 77.

The player 25 performs the kick motion for the ball object 81LP or the ball object 81RP which is positioned right under the question object, which is one of the question objects 79L and 79R in the screen 71P and corresponds to the English word in the question area 77 in the screen 71T.

The master processor 41 can recognize by the third command from the MCU 33 that the player 25 has performed the kick motion for the ball object 81LP or 81RP, and which of the ball objects 81LP and 81RP has been a target of the kick motion.

When the master processor 41 determines that the player 25 has performed the kick motion for the ball object corresponding to the correct answer based on the third command, i.e., in this example, since the English word in the question area 77 is “Apple”, when the master processor 41 determines that the player 25 has performed the kick motion for the ball object 81LP right under the question object 79L representing an “apple”, although the figure is omitted, the master processor 41 generates the video signal VD1 representing the video image of the ball object 81LP flying toward the upper side of the screen 15, and then supplies the projector 9 with it. In response to this, the projector 9 projects the video image corresponding to the video signal VD1 on the screen 15. Also, in this case, as shown in FIG. 7B, the master processor 41 arranges a result object 83 indicating the correct answer at a position where the ball object 81LP stood still in the image.

Further, when the ball object 81LP reaches the upper end of the screen 15, the master processor 41 instructs the slave processor 45 to generate the ball object 81LT. As shown in FIG. 7A, in response to this generation instruction, the slave processor 45 generates the video signal VD2 representing a video image, in which the ball object 81LT appears from the lower end of the screen 71T and moves toward the goal object 75, the goalkeeper object 73 jumps toward the ball object 81LT and fails to catch the ball object 81LT because the timing of the jump is off, and the goal is gotten. The slave processor 45 supplies the television monitor 5 with the video signal VD2. In response to this, the television monitor 5 displays the video image corresponding to the video signal VD2. In this case, the processors 41 and 45 generate the screens 71T and 71P respectively so that the trajectory of the ball object 81LP in the screen 71P is smoothly linked to the trajectory of the ball object 81LT in the screen 71T from the viewpoint of the player 25.

By generating and displaying these screens 71T and 71P, the player 25 can recognize that the answer is correct, and feel briskness as if he/she kicked a ball and got a goal.

Also, when it is determined that the player 25 gives a correct answer, the master processor 41 generates, at the same time as when the ball object 81LP starts to move from the still state, the audio signal AU1 representing sound as if a ball was exhilaratingly kicked. On the other hand, when the ball object 81LT reaches the goal object 75, the slave processor 45 generates the audio signal AU2 representing sound as if a ball was caught by a net.

Besides, although the figure is omitted, when the master processor 41 determines that the player 25 has performed the kick motion for the ball object corresponding to the incorrect answer based on the third command, i.e., in this example, since the English word in the question area 77 is “Apple”, when the master processor 41 determines that the player 25 has performed the kick motion not for the ball object 81LP right under the question object 79L representing an “apple” but for the ball object 81RP right under the question object 79R representing a “banana”, the master processor 41 generates the video signal VD1 representing the video image of the ball object 81RP flying toward the upper side of the screen 15, and then supplies the projector 9 with it. In response to this, the projector 9 projects the video image corresponding to the video signal VD1 on the screen 15. Also, in this case, the master processor 41 arranges a result object indicating the incorrect answer at a position where the ball object 81RP has stood still in the video image.

Also, when the ball object 81RP reaches the upper end of the screen 15, the master processor 41 instructs the slave processor 45 to generate the ball object 81RT. In response to this generation instruction, the slave processor 45 generates the video signal VD2 corresponding to a video image, in which the ball object 81RLT appears from the lower end of the screen 71T and moves toward the goal object 75, and the goalkeeper object 73 jumps toward the ball object 81LT in a timely manner and catches the ball object 81RT. The slave processor 45 supplies the television monitor 5 with the video signal VD2. In response to this, the television monitor 5 displays the video image corresponding to the video signal VD2. In this case, the processors 41 and 45 generate the screens 71T and 71P respectively so that the trajectory of the ball object 81RP in the screen 71P is smoothly linked to the trajectory of the ball object 81RT in the screen 71T from the viewpoint of the player 25.

By generating and displaying these screens 71T and 71P, the player 25 can recognize that the answer is incorrect, and feel chagrin as if he/she kicked a ball and could not get a goal.

Also, when it is determined that the player 25 gives an incorrect answer, the master processor 41 generates, at the same time as when the ball object 81RP starts to move from the still state, the audio signal AU1 representing to sound as if a ball was exhilaratingly kicked. On the other hand, when the ball object 81RT is caught by the goalkeeper object 73, the slave processor 45 generates the audio signal AU2 representing to sound as if a ball was caught.

By the way, although the figure is omitted, the English word is not displayed in the question area 77 in the screen 71T before the screen 71T of FIG. 6A and the screen 71P of FIG. 6B are generated.

Also, the question objects 79L and 79R, and the ball objects 81LP and 81RP are not displayed on the screen 71P. However, the screen 71P, in which contains a left footprint image which overlaps with the retroreflective sheet 19-1 and a right footprint image which overlaps with the retroreflective sheet 19-2, is generated to be projected.

Then, when the master processor 41 receives the first command, the master processor 41 generates the video signal VD1 representing the screen 71P of FIG. 6B. At the same time, the master processor 41 instructs the slave processor 45 to generate the screen 71T of FIG. 6A. In response to this generation instruction, the slave processor 45 generates the video signal VD2 representing the screen 71T.

By the way, a process of scanning the differential picture 89 will be described in detail. In this case, when the retroreflective sheets 17-1 to 17-3, and the retroreflective sheet 17-4 under the assumption that the retroreflective sheets 19-1 and 19-2 is single, are generically expressed, they are referred as retroreflective sheets 17-k (k=1, 2, 3, and 4). When the rectangular areas #1 to #4 corresponding to the retroreflective sheets 17-1 to 17-4 are generically expressed, they are referred as rectangular areas #k (k=1, 2, 3, and 4).

At the system startup, the minimum X coordinate, the maximum X coordinate, the minimum Y coordinate, and the maximum Y coordinate of the rectangular area #k are referred to as Bx[k][m], Ex[k][m], By[k], and Ey[k] (k=1, 2, 3, and 4) respectively. The element number “m” represents an image being included in the single rectangular area #k. Accordingly, m=0 at the system startup because the retroreflective sheet 17-k is not trodden on, and is not shaded.

During the system activation, the minimum X coordinate, the maximum X coordinate, the minimum Y coordinate, and the maximum Y coordinate of the rectangular area #k are referred to as bx[k][m], ex[k][m], by[k], and ey[k] (k=1, 2, 3, and 4) respectively. The element number “m” represents an image being included in the single rectangular area #k. Accordingly, m=0 if the image being included in the single rectangular area #k is one, i.e., the retroreflective sheet 17-k is not trodden on or is not shaded (the shade area is not present), m=0, 1 if the images being included in the single rectangular area #k are two, i.e., the retroreflective sheet 17-k is trodden on by the one foot or is shaded by the one foot (the shade area is one), and m=0, 1, 2 if the images being included in the single rectangular area #k are three, i.e., the retroreflective sheet 17-k is trodden on by both the feet or is shaded by the feet (the shade areas are two).

An image of the retroreflective sheet 17-k when it is not trodden on (or it is not shaded) is referred to as an image 90-k (k=1, 2, 3, 4). When the retroreflective sheet 17-k is trodden on the one foot (or is shaded by the one foot) and therefore the images being including in the single rectangular area #k are two, the images are referred to as the image k-0 and image k-1 from left, at that time, the shade area is referred to as the shade area k-5. When the retroreflective sheet 17-k is trodden on both the feet (or is shaded by both the feet) and therefore the images being including in the single rectangular area #k are three, the images are referred to as the image k-0, image k-1, and image k-2 from left, at that time, the two shade area are referred to as the shade area k-5 and k-6.

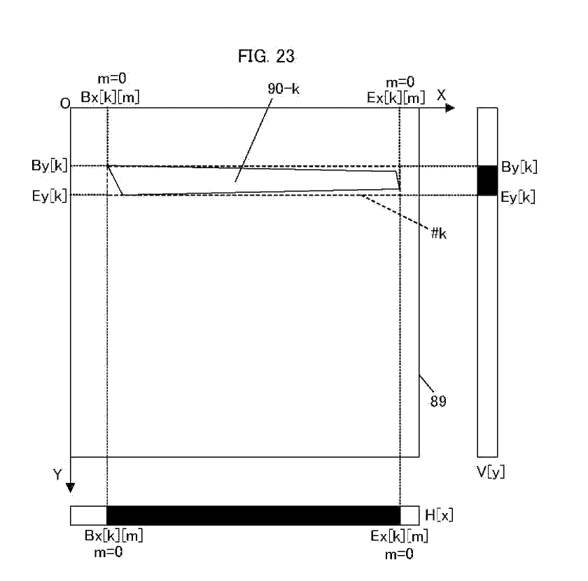

FIG. 23 is a detailed explanatory view for showing the scanning of the differential picture 89 at the system startup.

Referring to FIG. 23, the MCU 33 scans the differential picture 89 while increasing the X coordinate from X=0 to X=63 (horizontal scanning). Then, the MCU 33 increases a Y coordinate by one. Then, the MCU 33 performs the horizontal scanning. In this way, the MCU 33 performs the horizontal scanning till Y=63 while increasing the Y coordinate.

In this case, it is assumed that the differential picture 89 is a differential picture after binarizing and each pixel value is assigned to an array D[x][y]. The element number x corresponds to the X coordinate of the differential picture 89 while the element number y corresponds to the Y coordinate of the differential picture 89.

The value “1” is assigned to arrays V[y] and H[x] if the value “1” is assigned to the array D[x][y] (i.e., if it is a pixel constituting the image of the retroreflective sheet.) when scanning. Once the value “1” is assigned to the arrays V[y] and H[x], the value “1” is maintained in them.

Then, at the time when the scanning of 64 times 64 pixels is completed, the minimum element number y of the elements of the array V[y] to which the value “1” is assigned is the minimum Y coordinate By[k] which defines the rectangular area #k while the maximum element number y of the elements of the array V[y] to which the value “1” is assigned is the maximum Y coordinate Ey[k] which defines the rectangular area #k. Also, at the time when the scanning of 64 times 64 pixels is completed, the minimum element number x of the elements of the array H[x] to which the value “1” is assigned is the minimum X coordinate Bx[k][0] which defines the rectangular area #k while the maximum element number x of the elements of the array H[x] to which the value “1” is assigned is the maximum X coordinate Ex[k][0] which defines the rectangular area #k. Incidentally, the rectangular area #k is detected for each retroreflective sheet 17-k. Only the one image 90-k corresponding to the one retroreflective sheet 17-k is shown in FIG. 23 because of simplification.

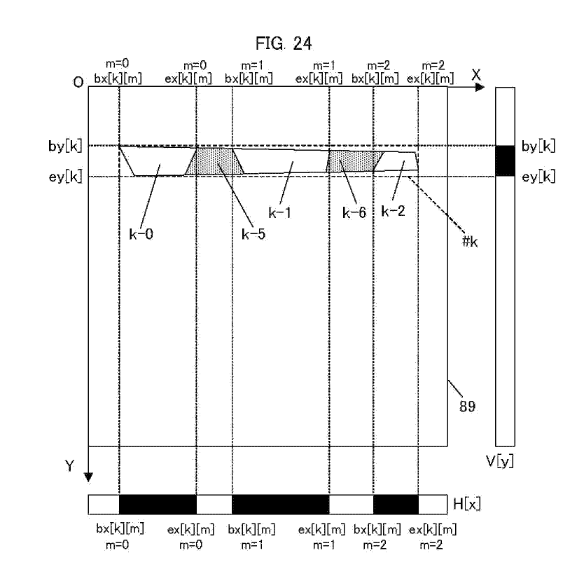

FIG. 24 is a detailed explanatory view for showing the scanning of the differential picture 89 during the system activation. Referring to FIG. 24, in a manner similar to that at the system startup, the MCU 33 performs the horizontal scanning till Y=63 while increasing the Y coordinate. In this case, algorism for assigning the values to the arrays V[y] and H[x] is the same as that at the system startup.

At the time when the scanning of 64 times 64 pixels is completed, the minimum element number y of the elements of the array V[y] to which the value “1” is assigned is the minimum Y coordinate by[k] which defines the rectangular area #k while the maximum element number y of the elements of the array V[y] to which the value “1” is assigned is the maximum Y coordinate ey[k] which defines the rectangular area #k.

Also, at the time when the scanning of 64 times 64 pixels is completed, the minimum element number x of the left-side elements of the array H[x] to which the value “1” is assigned is the minimum X coordinate bx[k][0] of the left-side image k-0 while the maximum element number x of the left-side elements of the array H [x] to which the value “1” is assigned is the maximum X coordinate ex[k][0] of the left-side image k-0. At the when the scanning of 64 times 64 pixels is completed, the minimum element number x of the middle elements of the array H[x] to which the value “1” is assigned is the minimum. X coordinate bx[k][1] of the middle image k-1 while the maximum element number x of the middle elements of the array H[x] to which the value “1” is assigned is the maximum X coordinate ex[k][1] of the middle image k-1. At the time when the scanning of 64 times 64 pixels is completed, the minimum element number x of the right-side elements of the array H[x] to which the value “1” is assigned is the minimum X coordinate bx[k][2] of the right-side image k-2 while the maximum element number x of the right-side elements of the array H[x] to which the value “1” is assigned is the maximum X coordinate ex[k][2] of the right-side image k-2.

Incidentally, these processes are performed for each retroreflective sheet 17-k. Only the images k-0 to k-2 corresponding to the one retroreflective sheet 17-k are shown in FIG. 23 because of simplification. Incidentally, while the three images are present in the single rectangular area #k in the example of FIG. 24, there may be one image or two images. Also, in this example, the minimum X coordinate of the rectangular area #k is the minimum X coordinate bx[k][0] of the image k-0 while the maximum X coordinate is the maximum X coordinate ex[k][2] of the image k-2.

Incidentally, the dimension of the rectangular area #k at the system startup may be different from the dimension during the system activation. Because the player 25 may tread on the left end or right end of the retroreflective sheet 17-k, or it may be shaded.

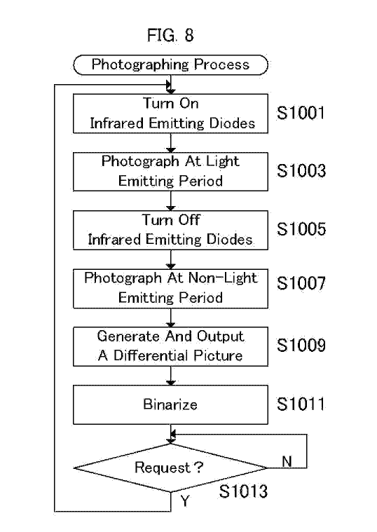

FIG. 8 is a flow chart for showing an example of the photographing process by the MCU 33 of FIG. 2. Referring to FIG. 8, in step S1001, the MCU 33 makes the image sensor 31 turn the infrared light emitting diode 23 on. In step S1003, the MCU 33 makes the image sensor 31 perform the photographing process in the time when the infrared light is emitted. In step S1005, the MCU 33 makes the image sensor 31 turn the infrared light emitting diode 23 off.

In step S1007, the MCU 33 makes the image sensor 31 perform the photographing process in the time when the infrared light is not emitted. In step S1009, the MCU 33 makes the image sensor 31 generate and output the differential picture (camera image) between the picture in the time when the infrared light is emitted and the picture in the time when the infrared light is not emitted. In step S1011, the MCU 33 compares each pixel of the differential picture generated by the image sensor 31 with a predetermined threshold value to binarize, and stores them in the array D[x][y]. Incidentally, it is determined that the pixel constitutes the image of the retroreflective sheet if the pixel exceeds the threshold value, and then the value “1” is assigned, otherwise it is determined that the pixel does not constitute the image of the retroreflective, and then the value “0” is assigned. The element number x corresponds to the X coordinate of the differential picture while the element number y corresponds to the Y coordinate of the differential picture.

In step S1013, the MCU 33 proceeds to step S1001 if the MCU 33 receives the request signal from the master processor 41, conversely the process returns to the step S1013 if the MCU 33 does not receive it.

As described above, the image sensor 31 performs the photographing process in the time when the infrared light is emitted and the photographing process in the time when the infrared light is not emitted, i.e., the stroboscope imaging, in accordance with the control by the MCU 33. Also, the infrared light emitting diodes 23 operate as a stroboscope by the above control.

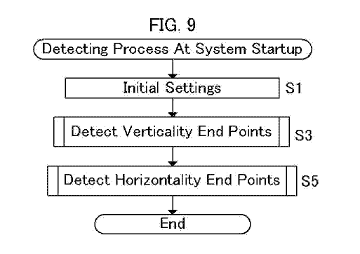

FIG. 9 is a flow chart for showing an example of the detecting process by the MCU 33 of FIG. 2 at the system startup. Referring to FIG. 9, in step S1, the MCU 33 performs initial settings which are acquired at the system startup. In step S3, the MCU 33 performs the process for detecting the minimum Y coordinate and the maximum Y coordinate (verticality end points) of the rectangular area #k from the binarized differential picture D[x][y]. In step S5, the MCU 33 performs the process for detecting the minimum X coordinate and the maximum X coordinate (horizontality end points) of the rectangular area #k from the binarized differential picture D[x][y]. The rectangular area #k is detected by the above steps S3 and S5.

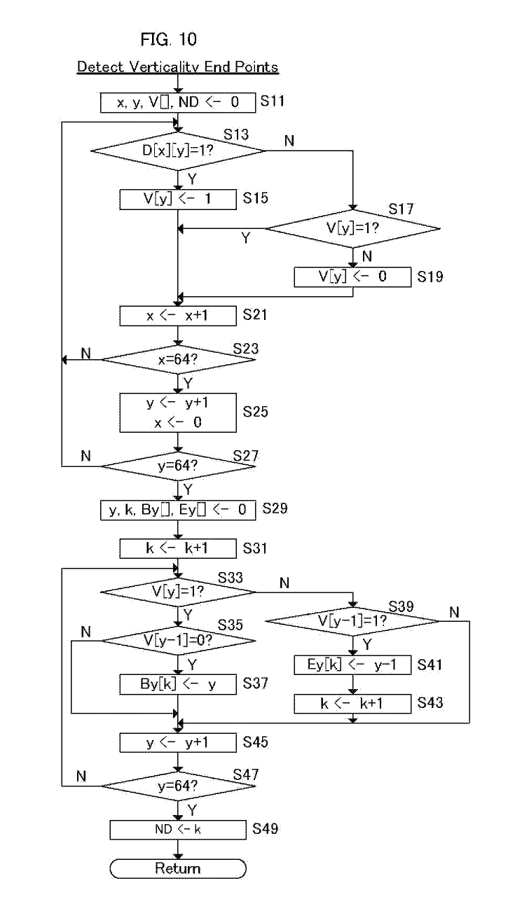

FIG. 10 is a flow chart for showing an example of the process for detecting the verticality end points in the step S3 of FIG. 9. Referring to FIG. 10, in step S11, the MCU 33 sets variables x, y, and ND, and the array V[ ] to 0. The variables x and y correspond to the X coordinate and Y coordinate of the differential picture respectively.

In step S13, the MCU 33 determines whether or not the value of the array D[x][y] constituting the binarized differential picture is equal to 1, the process proceeds to step S15 if it is equal to 1, otherwise the process proceeds to step S17. In step S15, the MCU 33 assigns 1 to the variable V[y], and then proceeds to step S21. On the other hand, in step S17, the MCU 33 determines whether or not the value “1” is already stored in the variable V[y], the process proceeds to step S21 if it is stored, conversely the process proceeds to step S19 if it is not stored. In step S19, the MCU 33 assigns 0 to the variable V[y], and then proceeds to step S21.

In step S21, the MCU 33 increases the variable x by one. In step S23, the MCU 33 determines whether or not the value of the variable x is equal to 64, the process proceeds to step S25 if it is equal to 64 (the completion of the one horizontal scanning), otherwise the process returns to step S13.

In step S25, the MCU 33 increases the variable y by one, and then assigns 0 to the variable x. In step S27, the MCU 33 determines whether or not the value of the variable y is equal to 64, the process proceeds to step S29 if it is equal to 64 (the completion of all the horizontal scanning), otherwise the process returns to step S13.

In step S29, the MCU 33 sets the variables y and k, and the arrays By and Ey[ ] to 0. In step S31, the MCU 33 increases a counter k by one.

The value of the counter k has the same meaning as the above symbol k. This point is also true regarding the flowcharts to be described below.

In step S33, the MCU 33 determines whether or not the value of the variable V[y] is equal to 1, the process proceeds to step S35 if it is equal to 1, otherwise the process proceeds to step S39.

In step S35, the MCU 33 determines whether or not the value of the variable V[y−1] is equal to 0, the process proceeds to step S37 if it is equal to 0, otherwise the process proceeds to step S45. In step S37, the MCU 33 assigns the value of the y to the variable By[k], and then proceeds to step S45. On the other hand, in step S39, the MCU 33 determines whether or not the value of the variable V[y−1] is equal to 1, the process proceeds to step S41 if it is equal to 1, otherwise the process proceeds to step S45. In step S41, the MCU 33 assigns y−1 to the variable Ey[k]. In step S43, the MCU 33 increases the counter k by one, and then proceeds to step S45.

In step S45, the MCU 33 increases the variable y by one. In step S47, the MCU 33 determines whether or not the value of the variable y is equal to 64, the process proceeds to step S49 if it is equal to 64, otherwise the process returns to step S33. In step s49, the MCU 33 assigns the value of the variable k to the variable ND, and then returns.

The array By[k] indicates the minimum Y coordinate of the rectangular area #k while the array Fy[k] indicates the maximum Y coordinate of the rectangular area #k. Accordingly, the variable ND indicates the number of the rectangular areas #k as detected. Up to four rectangular areas can be detected. Incidentally, in the case where the feet are placed on the retroreflective sheets 19-1 and 19-2 respectively, the three rectangular areas are detected.

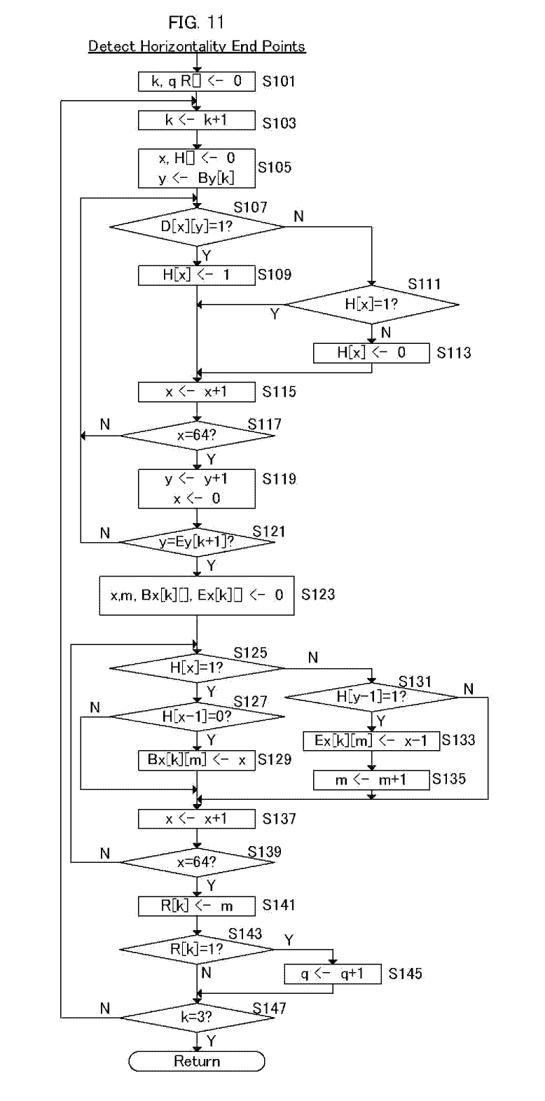

FIG. 11 is a flow chart for showing an example of the process for detecting the horizontality end points in the step S5 of FIG. 9. Referring to FIG. 11, in step S101, the MCU 33 sets variables k and q, and the array R[ ] to 0. In step S103, the MCU 33 increases a counter k by one. In step S105, the MCU 33 assigns 0 to the variable x and the array H[ ], and assigns the value of the array By[k] to the variable y.

In step S107, the MCU 33 determines whether or not the value of the array D[x][y] constituting the differential picture is equal to 1, the process proceeds to step S109 if it is equal to 1, otherwise proceeds to step S111. In step S109, the MCU 33 assigns 1 to the variable H[x], and then proceeds to step S115. On the other hand, in step S111, the MCU? 33 determines whether or not the value 1 is already stored in the variable H[x], the process proceeds to step S115 if it is stored, conversely the process proceeds to step S113 if it is not stored. In step S113, the MCU 33 assigns 0 to the variable H[x], and then proceeds to step S115.

In step S115, the MCU 33 increases the variable x by one. In step S117, the MCU 33 determines whether or not the value of the variable x is equal to 64, the process proceeds to step S119 if it is equal to 64 (the completion of the one horizontal scanning), otherwise returns to step S107.

In step S119, the MCU 33 increases the variable y by one, and assigns 0 to the variable x. In step S121, the MCU 33 determines whether or not the value of the variable y is equal to the value of the array Ey[k+1], the process proceeds to step S123 if it is equal, otherwise the process returns to step S107.

In step S123, the MCU 33 assigns 0 to the variables x and m, and the arrays Bx[k][0] and Ex[k][ ]. In step S125, the MCU 33 determines whether or not the value of the variable H[x] is equal to 1, the process proceeds to step S127 if it is equal to 1, otherwise the process proceeds to step S131. In step S127, the MCU 33 determines whether or not the value of the array H[x−1] is equal to 0, the process proceeds to step S129 if it is equal to 0, otherwise the process proceeds to step S137. In step S129, the MCU 33 assigns the value of the variable x to the array Bx[k][m]. On the other hand, in step S131, the MCU 33 determines whether or not the value of the array H[y−1] is equal to 1, the process proceeds to step S133 if it is equal to 1, otherwise the process proceeds to step S137. In step S133, the MCU 33 assigns x−1 to the array Ex[k][m]. In step S135, the MCU 33 increases a counter m by one, and then proceeds to step S137.

The value of the counter m has the same meaning as the above symbol m. This point is also true regarding the flowcharts to be described below.

In step S137, the MCU 33 increases the value of the variable x by one. In step S139, the MCU 33 determines whether or not the value of the variable x is equal to 64, the process proceeds to step S141 if it is equal to 64 (the completion of the one horizontal scanning), otherwise the process returns to step S125.

In step S141, the MCU 33 assigns the value of the variable m to the array R[k]. The value of the array R[k] indicates the number of the images being contained in the single rectangular area #k. In step S143, the MCU 33 determines whether or not the value of the variable R[k] is equal to 1, the process proceeds to step S145 if it is equal to 1, otherwise the process proceeds to step S147. In step S145, the MCU 33 increases the value of the variable q by one. In step S147, the MCU 33 determines whether or not the value of the variable k is equal to 3, the process returns if it is equal to 3, otherwise the process proceeds to step S103. Because the minimum X coordinate and the maximum Y coordinate of the rectangular area #4 corresponding to the images 92-1 and 92-2 are not used in the subsequent processing.

Incidentally, in the case where the value of the variable q after determining the positive determination in step S147 is 3, the case indicates that only one image is contained in each of the three rectangular areas #1 to #3. That is, the case indicates that the player 25 does not stand on all the retroreflective sheets 17-1 to 17-3, and they are not shaded.

Also, the value of the array Bx[k][m] indicates the minimum X coordinate defining the rectangular area #k while the value of the array Ex[k][m] indicates the maximum X coordinate defining the rectangular area #k. However, since only one image is present in one rectangular area #k at the system startup, these are Bx[k][0] and Ex[k][0] respectively.

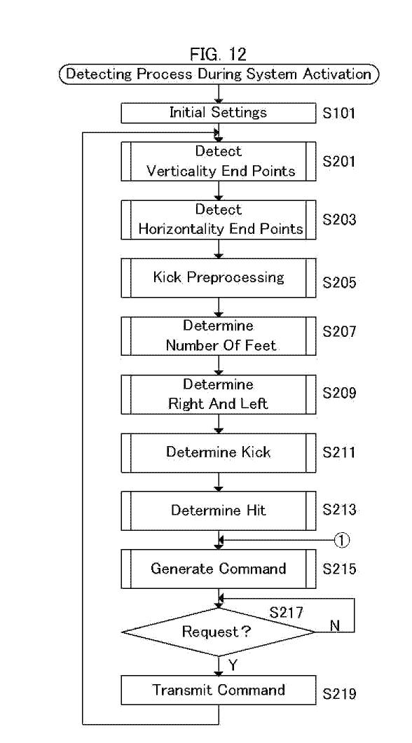

FIG. 12 is a flow chart for showing an example of the detecting process by the MCU 33 of FIG. 2 during the system activation. Referring to FIG. 12, in step S101, the MCU 33 performs initial settings which are acquired during the system activation. A first to fifth kick flags to be described below are initialized in the initial settings.

In step S201, the MCU 33 detects the minimum Y coordinate and the maximum Y coordinate (the verticality end points) of each image included in the respective rectangular areas #k from the binarized differential picture D[x][y]. The process of step S201 is the same as the process for detecting the verticality end points shown in FIG. 10, and therefore the description thereof is omitted. However, in FIG. 10, the array By[k] is replaced by the array by[k], and the array Ey[k] is replaced by the array ey[k].

In step S203, the MCU 33 detects the minimum X coordinate and the maximum X coordinate (the horizontality end points) of each image included in the respective rectangular areas #k from the binarized differential picture D[x][y]. The process of step S203 is the same as the process for detecting the horizontality end points shown in FIG. 11, and therefore the description thereof is omitted. However, in FIG. 11, the array Bx[k][m] is replaced by the array bx[k][m], and the array Ex[k][m] is replaced by the array ex[k][m].

In step S205, the MCU 33 performs kick preprocessing. In step S207, the MCU 33 performs the process for determining the number of the feet on the screen 15. In step S209, the MCU 33 performs the right-left determining process regarding the feet of the player 25 on the screen 15. In step S211, the MCU 33 performs the process for determining whether or not the player 25 performs the kick motion. In step S213, the MCU 33 performs the process for determining whether or not the kick motion hits either the ball object 81LP or 81RP. In step S215, the MCU 33 generates the command CD based on the result of the processing in the step S201 to S213.

In step S217, the MCU 33 determines whether or not the MCU 33 receives the request signal from the master processor 41, the process returns to step S217 if it is not received, conversely the process proceeds to step S219 if it is received. In step S219, the MCU 33 transmits the command CD generated in step S215 to the master processor 41, and then proceeds to step S201.

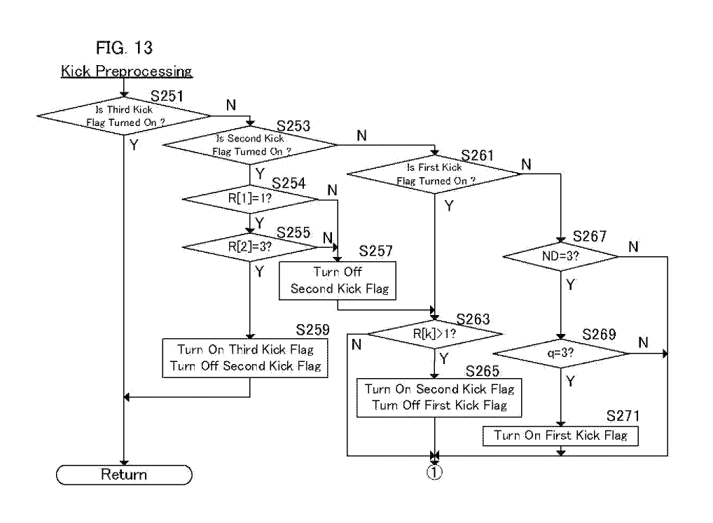

FIG. 13 is a flow chart for showing an example of the kick preprocessing in the step S205 of FIG. 12. Referring to FIG. 13, in step S251, the MCU 33 determines whether or not the third kick flag is turned on, the process returns if it is turned on, conversely the process proceeds to step S253 if it is turned off. In step S253, the MCU 33 determines whether or not the second kick flag is turned on, the process proceeds to step S255 if it is turned on, conversely the process proceeds to step S261 if it is turned off.

In step S254, the MCU 33 determines whether or not the array R[1] is equal to 1, i.e., whether or not only the single image is contained in the rectangular area #2 corresponding to the retroreflective sheet 17-1, the process proceeds to step S255 if it is equal to 1, otherwise the process proceeds to step S257. In the case where only the single image is contained in the rectangular area #1, it indicates that the player 25 does not stand on the retroreflective sheet 17-1, and it is not shaded.

In step S255, the MCU 33 determines whether or not the value of the array R[2] is equal to 3, i.e., whether or not the three images are contained in the rectangular area #2 corresponding to the retroreflective sheet 17-2, the process proceeds to step S259 if it is equal to 3, otherwise the process proceeds to step S257. In the case where the three images are contained in the rectangular area #2, it indicates that both the feet are placed on the retroreflective sheet 17-2 (or it is shaded by both the feet) and the two shade areas are present. Accordingly, in step S259, the MCU 33 turns on the third kick flag, turns off the second kick flag, and then returns. Also, in step S257, the MCU 33 turns off the second kick flag, and then proceeds to step S263.

In step S261, the MCU 33 determines whether or not the first kick flag is turned on, the process proceeds to step S263 if it is turned on, conversely the process proceeds to step S267 if it is turned off. In step S263, the MCU 33 determines whether or not any one of the arrays R[1], R[2], and R[3] exceeds 1, i.e., whether or not one foot or both feet is/are placed on any one of the retroreflective sheets 17-1, 17-2 and 17-3 and any one of the retroreflective sheets 17-1, 17-2 and 17-3 is shaded by one foot or both feet, the process proceeds to step S265 if the positive determination, otherwise the process proceeds to step S215 of FIG. 12. In step S265, the MCU 33 turns on the second kick flag, turns off the first kick flag, and then proceeds to step S215 of FIG. 12.

In step S267, the MCU 33 determines whether or not the value of the variable ND is equal to 3, i.e., whether or not the number of the detected rectangular areas #k is equal to 3, the process proceeds to step S269 if it is equal to 3, otherwise the process proceeds to step S215 of FIG. 12. In the case where the number of the rectangular areas 4k is equal to 3, it indicates that the images 92-1 and 92-2 of the retroreflective sheets 19-1 and 19-2 are not detected. In step S269, the MCU 33 determines whether or not the value of the variable q is equal to 3, i.e., whether or not only single image is contained in each of the three rectangular areas #1 to #3, the process proceeds to step S271 if it is equal to 3, otherwise the process proceeds to step S215 of FIG. 12. In step S271, the MCU 33 turns on the first kick flag, and then proceeds to step S215 of FIG. 12.

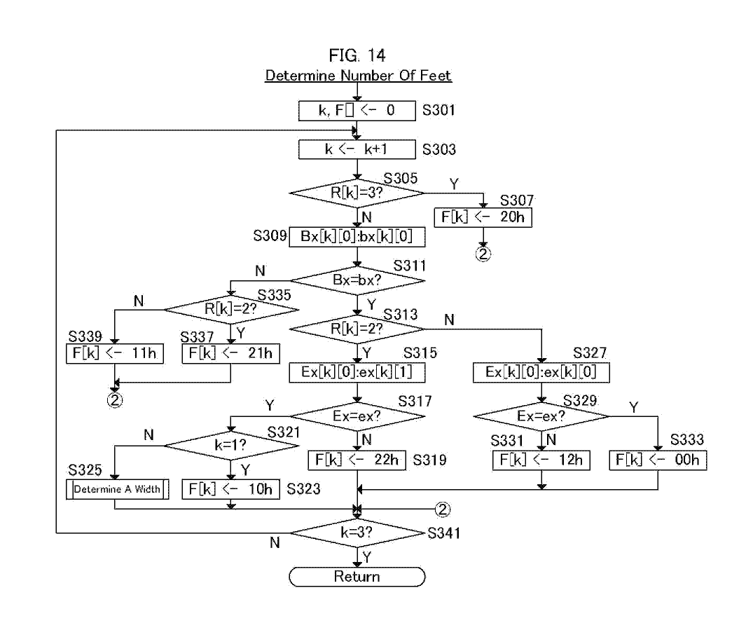

FIG. 14 is a flow chart for showing an example of the process for determining the number of the feet in the step S207 of FIG. 12. Referring to FIG. 14, in step S301, the MCU 33 sets the variable k and the array F[ ] to 0. In step S303, the MCU 33 increases a counter k by one. In step S305, the MCU 33 determines whether or not the value of the array R[k] is equal to 3, the process proceeds to step S307 if it is equal to 3, otherwise the process proceeds to step S309. In step S307, the MCU 33 assigns 20h, which indicates that the three images are contained in the rectangular area #k and therefore the two shade areas (both feet) are present, to the array F[k], and then proceeds to step S341.

In step S309, the MCU 33 compares the value of the array Bx[k][0] (the minimum X coordinate of the rectangular area #k at the system startup) with the value of the array bx[k][0] (the minimum X coordinate of the current rectangular area #k).

In step S311, the MCU 33 proceeds to step S313 if the value of the array Bx[k][0] is equal to the value of the array bx[k][0], i.e., the left end of the retroreflective sheet corresponding to the rectangular area #k is not trodden on, conversely the process proceeds to step S335 if otherwise, i.e., the left end is trodden on. In step S335, the MCU 33 determines whether or not the value of the array R[k] is equal to 2, the process proceeds to step S337 if it is equal to 2, otherwise the process proceeds to step S339. In step S337, the MCU 33 assigns 21h, which indicates that the left end and the other part of the retroreflective sheet 17-k corresponding to the rectangular area #k are trodden on, to the array F[k], and then proceeds to step S341. Also, in step S339, the MCU assigns 11h, which indicates that the left end of the retroreflective sheet 17-k corresponding to the rectangular area #k is trodden on and the other part of the retroreflective sheet 17-k is not trodden on, to the array F[k], and then proceeds to step S341.

In step S313, the MCU 33 determines whether or not the value of the array R[k] is equal to 2, the process proceeds to step S315 if it is equal to 2, otherwise the process proceeds to step S327. In step S327, the MCU 33 compares the value of the array Ex[k][0] (the maximum X coordinate of the rectangular area #k at the system startup) with the value of the array ex[k][0] (the maximum X coordinate of the current rectangular area #k). In step S329, the MCU 33 proceeds to step S333 if the value of the array Ex[k][0] is equal to the value of the array ex[k][0], otherwise the process proceeds to step S331. In step S333, the MCU 33 assigns 00h, which indicates that the retroreflective sheet 17-k corresponding to the rectangular area #k is not trodden on, to the array F [k]. In step S331, the MCU 33 assigns 12h, which indicates that the right end of the retroreflective sheet 17-k corresponding to the rectangular area #k is trodden on and the other part of the retroreflective sheet 17-k is not trodden, to the array F [k].

In step S315, the MCU 33 compares the value of the array Ex[k][0] (the maximum X coordinate of the rectangular area #k at the system startup) with the value of the array ex[k][1] (the maximum X coordinate of the current rectangular area #k). In step S317, the MCU 33 proceeds to step S321 if the value of the array Ex[k][0] is equal to the value of the array ex[k][1], otherwise the process proceeds to step S319. In step S319, the MCU 33 assigns 22h, which indicates that the right end and the other part of the retroreflective sheet 17-k corresponding to the rectangular area #k are trodden on, to the array F[k].

In step S321, the MCU 33 determines whether or not the value of the counter k is equal to 1, the process proceeds to step S323 if it is equal to 1, otherwise the process proceeds to step S325. In step S323, the MCU 33 assigns 10h, which indicates that the part other than the right and left ends of the retroreflective sheet 17-1 corresponding to the rectangular area #1 is trodden on with the one foot (or is shaded by the one feet), to the array F[k]. In step S325, the MCU 33 performs a process for determining a width.

In step S341, the MCU 33 determines whether or not the counter k becomes 3, the process returns if it becomes 3, otherwise the process returns to step S303.

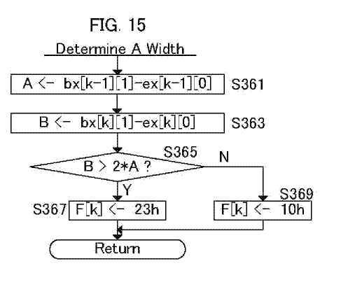

FIG. 15 is a flow chart for showing an example of the process for determining the width in the step S325 of FIG. 14. Referring to FIG. 15, in step S361, the MCU 33 assigns a value obtained by the following formula to a variable A.

A<-bx[k−1][1]−ex[k−1][0]

The variable bx[k−1][1] is the minimum X coordinate of the second image from left contained in the rectangular area #k−1 just below rectangular area #k, and the variable ex[k−1][0] is the maximum X coordinate of the first image from left contained in the rectangular area #k−1. That is, the variable A indicates the width of the shade area contained in the rectangular area #k−1.

Also, in step S363, the MCU 33 assigns a value obtained by the following formula to a variable B.

B<-bx[k][1]−ex[k][0]

The variable bx[k][1] is the minimum X coordinate of the second image from left contained in the rectangular area #k, and the variable ex[k][0] is the maximum X coordinate of the first image from left contained in the rectangular area #k. That is, the variable B indicates the width of the shade area contained in the rectangular area #k.

Then, in step S365, the MCU 33 determines whether or not the value of the variable B exceeds the doubled value of the variable A, the process proceeds to step S367 if it exceeds, otherwise the process proceeds to step S369. In step S367, the MCU 33 assigns 23h, which indicates that the retroreflective sheet 17-k corresponding to the rectangular area #k are trodden on both feet which are approximate each other, to the array F[k], and then returns. In step S369, the MCU 33 assigns 10h to the variable F[k], and then returns.

Next, a value which can be assigned to the variable F[k] will be organized. The value 20h indicates that the three images are contained in the rectangular area #k and thereby the two shade areas (feet) are present. The value 21h indicates that the left end and the other part of the retroreflective sheet 17-k corresponding to the rectangular sheet #k are trodden on (or shaded). The value 11h indicates that the left end of the retroreflective sheet 17-k corresponding to the rectangular sheet #k is trodden on (or shaded) and the other part of the retroreflective sheet 17-k is neither trodden on nor shaded. The value 00h indicates that the retroreflective sheet 17-k corresponding to the rectangular sheet #k is neither trodden on nor shaded. The value 12h indicates that the right end of the retroreflective sheet 17-k corresponding to the rectangular sheet #k is trodden on (or shaded) and the other part of the retroreflective sheet 17-k is neither trodden on nor shaded. The value 22h indicates that the right end and the other part of the retroreflective sheet 17-k corresponding to the rectangular sheet #k are trodden on (or shaded). The value 10h indicates that the single foot is placed on the part other than the right and left ends of the retroreflective sheet 17-1 corresponding to the rectangular sheet #1 (or it is shaded by the single foot.). The value 23h indicates that the retroreflective sheet 17-k corresponding to the rectangular sheet #k is trodden on both feet which are appropriate each other (or is shaded by both feet which are appropriate each other.). That is, since both the feet are appropriate each other, the shade areas which should be originally two are not separated.

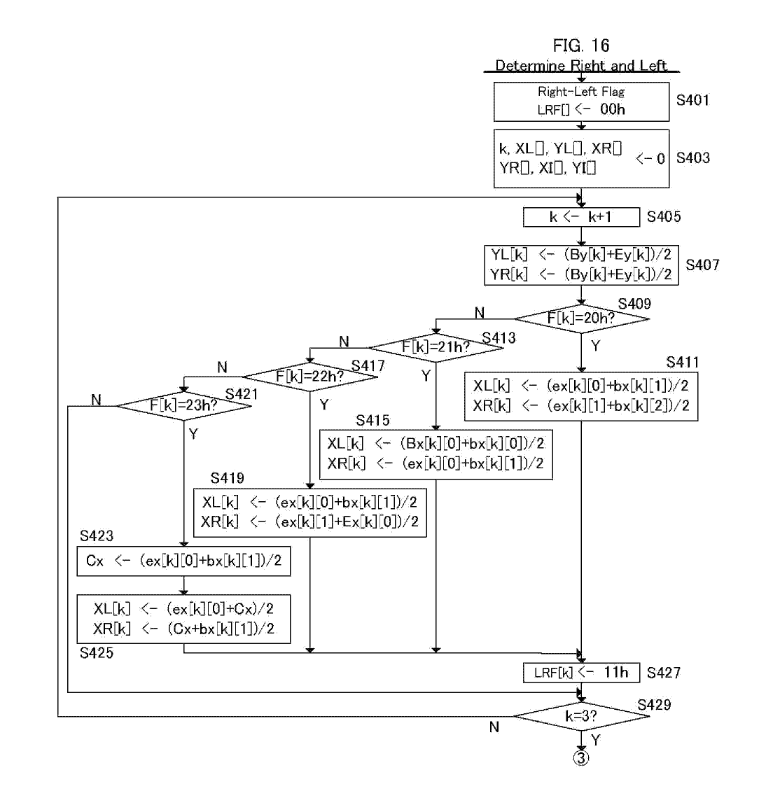

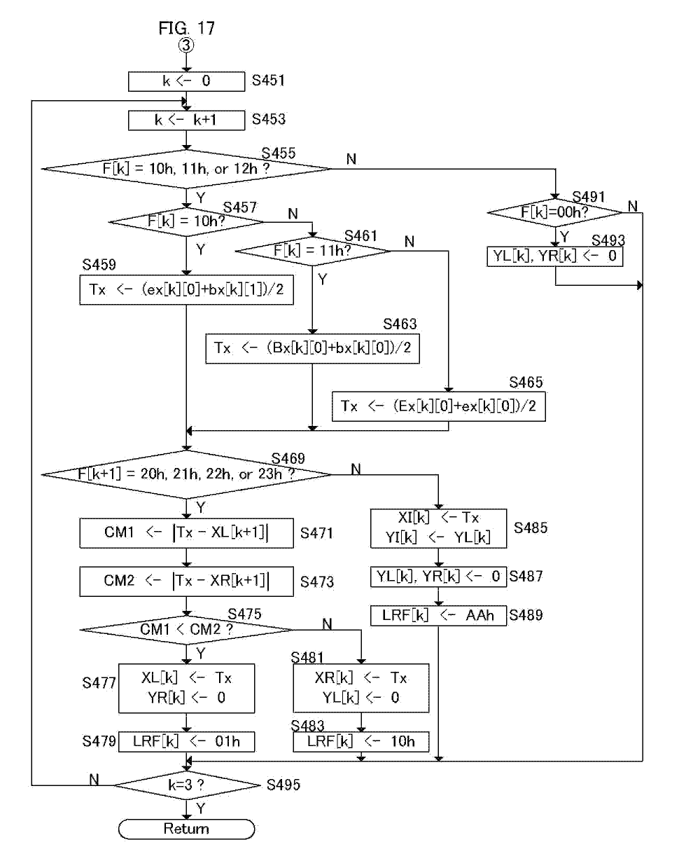

FIGS. 16 and 17 are flow charts for showing an example of the right-left determining process in the step S209 of FIG. 13. Referring to FIG. 16, in step S401, the MCU 33 sets a right-left flag LRF[ ] to 00h. In step S403, the MCU 33 sets a variable k, and arrays XL[ ], YL[ ], XR[ ], YR[ ], XT[ ], and YI[ ] to 0.

In step S405, the MCU 33 increases the counter k by one. In step S407, the values obtained by the following formulae are assigned to the variables YL[k] and YR[k].

YL[k]<-(By[k]+Ey[k])/2

YR[k]<-(By[k]+Ey[k])/2

The variable YL[k] indicates the Y coordinate of the shade area which corresponds to the left foot and is contained in the rectangular area #k, i.e., the Y coordinate of the left foot. The variable YR[k] indicates the Y coordinate of the shade area which corresponds to the right foot and is contained in the rectangular area #k, i.e., the Y coordinate of the right foot.

In step S409, the MCU 33 determines whether or not the value of the variable F[k] is 20h, the process proceeds to step S411 if it is 20h, otherwise the process proceeds to step S413. In step S411, the MCU 33 assigns the values obtained by the following formulae to the variables XL[k] and XR[k] respectively.

XL[k]<-(ex[k][0]+bx[k][1])/2

XR[k]<-(ex[k][1]+bx[k][2])/2

The variable XL[k] indicates the X coordinate of the shade area which corresponds to the left foot and is contained in the rectangular area #k, i.e., the X coordinate of the left foot. The variable XR[k] indicates the X coordinate of the shade area which corresponds to the right foot and is contained in the rectangular area #k, i.e., the X coordinate of the right foot.

In step S413, the MCU 33 determines whether or not the value of the variable F[k] is 21h, the process proceeds to step S415 if it is 21h, otherwise the process proceeds to step S417. In step S415, the MCU 33 assigns the values obtained by the following formulae to the variables XL[k] and XR[k] respectively.

XL[k]<-(Bx[k][0]+bx[k][0])/2

XR[k]<-(ex[k][0]+bx[k][1])/2

In step S417, the MCU 33 determines whether or not the value of the variable F[k] is 22h, the process proceeds to step S419 if it is 22h, otherwise the process proceeds to step S421. In step S419, the MCU 33 assigns the values obtained by the following formulae to the variables XL[k] and XR[k] respectively.

XL[k]<-(ex[k][0]+bx[k][1])/2

XR[k]<-(ex[k][1]+Ex[k][0])/2

In step S421, the MCU 33 determines whether or not the value of the variable F[k] is 23h, the process proceeds to step S423 if it is 23h, otherwise the process proceeds to step S429. In step S423, the value obtained by the following formula is assigned to the variable Cx.

Cx<-(ex[k][0]+bx[k][1])/2

In step S425, the MCU 33 assigns the values obtained by the following formulae to the variables XL[k] and XR[k] respectively.

XL[k]<-(ex[k][0]+Cx)/2

XR[k]<-(Cx+bx[k][1])/2

In step S427, the MCU 33 assigns 11h, which indicates that the two shade areas (i.e., both feet) are present in the rectangular area #k, to the right-left flag LRF[k]. In step S429, the MCU 33 determines whether or not the value of the counter k is 3, the process proceeds to step S451 of FIG. 17 if it is 3, otherwise the process returns to step S405.

Referring to FIG. 17, in step S451, the MCU 33 assigns 0 to the variable k. In step S453, the MCU 33 increases the variable k by one. In step S455, the MCU 33 determines whether or not the value of the variable F[k] is any one of 10h, 11h, and 12h, the process proceeds to step S457 if the positive determination, conversely the process proceeds to step S491 if the negative determination. In step S491, the MCU 33 determines whether or not the value of the variable F[k] is 00h, the process proceeds to step S493 if the positive determination, conversely the process proceeds to step S495 if the negative determination. In step S493, the MCU 33 assigns 0 to the respective variables YL[k] and YR[k], and then proceeds to step S495.

In step S457, the MCU 33 determines whether or not the value of the variable F[k] is 10h, the process proceeds to step S459 if it is 10h, otherwise, the process proceeds to step S461. In step S459, the MCU 33 assigns the value obtained by the following formula to the variable Tx. The variable Tx indicates the X coordinate of the single shade area contained in the rectangular area #k.

Tx<-(ex[k][0]+bx[k][1])/2

In step S461, the MCU 33 determines whether or not the value of the variable F[k] is 11, the process proceeds to step S463 if it is 11h, otherwise, the process proceeds to step S465. In step S463, the MCU 33 assigns the value obtained by the following formula to the variable Tx.

T<-(Bx[k][0]+bx[k][0])/2

In step S465, the MCU 33 assigns the value obtained by the following formula to the variable Tx.

Tx<-(Ex[k][0]+ex[k][0])/2

In step S469, the MCU 33 determines whether or not the value of the variable F[k+1] is any one of 20h, 21h, 22h, and 23h, the process proceeds to step S471 if the positive determination, conversely the process proceeds to step S485 if the negative determination.

In step S485, the MCU 33 assigns the values obtained by the following formulae to the variables XI[k] and YI[k] respectively.

XI[k]<-Tx

YI[k]<-YL[k]

In the case where a single shade area is present in the rectangular area #k while the right and left can not be determined (the right and left are indefinite.), the XY coordinates of the shade area are assigned to the variables XI[k] and YI[k].

In step S487, the MCU 33 assigns 0 to the respective variables YL[k] and YR[k]. In step S489, the MCU 33 assigns AAh, which indicates that it is indefinite which of right and left the only one shade area in the rectangular area #k corresponds to, to the right-left flag LRF[k].

In step S471, the MCU 33 assigns the values obtained by the following formulae to the variables CM1 and CM 2 respectively.

CM1<-|Tx−XL[k+1]

CM2<-|Tx−XR[k+1]

The variable CM1 is the absolute value of the difference between the X coordinate of the shade area of the rectangular area 4k and the X coordinate of the left shade area of the rectangular area #k+1 just below the rectangular area #k. The variable CM2 is the absolute value of the difference between the X coordinate of the shade area of the rectangular area #k and the X coordinate of the right shade area of the rectangular area #k+1 just below the rectangular area #k.

In step S475, the MCU 33 determines whether or not the value of the variable CM1 is less than the value of CM2, the process proceeds to step S477 if it is less, i.e., the X coordinate of the shade area of the rectangular area #k is closer to the X coordinate of the left shade area of the rectangular area #k+1, conversely the process proceeds to step S481 if otherwise, i.e., the X coordinate of the shade area of the rectangular area #k is closer to the X coordinate of the right shade area of the rectangular area #k+1.

In step S477, the MCU 33 assigns the values obtained by the following formulae to the variables XL[k] and YR[k] respectively.

XL[k]<-Tx

YR[k]<-0

In step S479, the MCU 33 assigns 01h, which indicates that the only one shade area of the rectangular area #k corresponds to the left foot, to the flag LRF[k].

In step S481, the MCU 33 assigns the values obtained by the following formulae to the variables XR[k] and YL[k] respectively.

XR[k]<-Tx

YL[k]<-0

In step S483, the MCU 33 assigns 10h, which indicates that the only one shade area of the rectangular area #k corresponds to the right foot, to the flag LRF[k].

In step S495, the MCU 33 determines whether or not the value of the variable k is 3, the process returns if it is 3, otherwise the process proceeds to step S453.

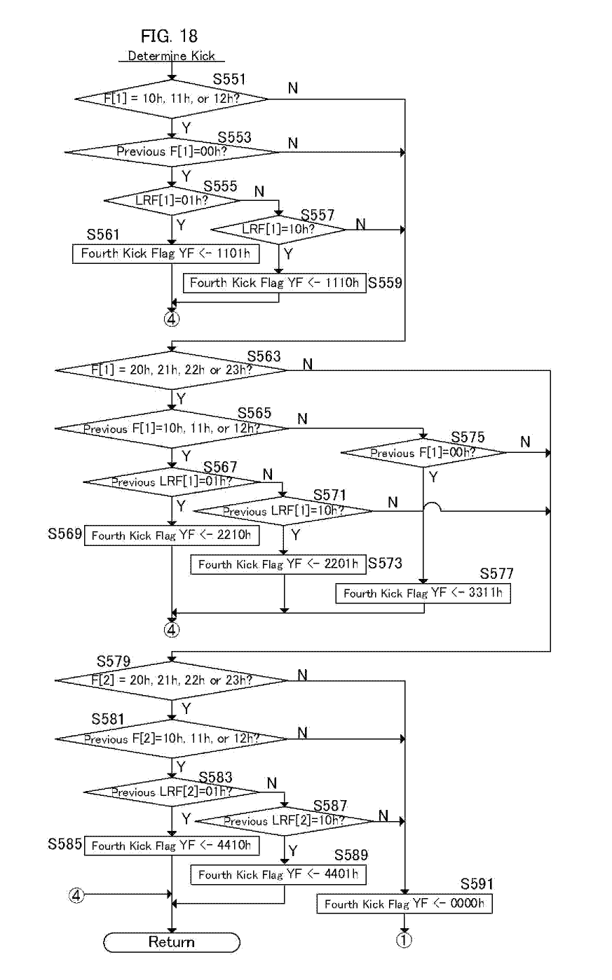

FIG. 18 is a flow chart for showing an example of the kick determining process in the step S211 of FIG. 13. Referring to FIG. 18, in step S551, the MCU 33 determines whether or not the variable F[1] is any one of 10h, 11h, and 12h, the process proceeds to step S553 if the positive determination, conversely the process proceeds to step S563 if the negative determination.

In step S553, the MCU 33 determines whether or not the previous value of the variable F[1] is 00h, the process proceeds to step S555 if it is 00h, otherwise the process proceeds to step S563. In step S555, the MCU 33 determines whether or not the right-left flag LRF[1] is 01h, the process proceeds to step S561 if it is 01h, otherwise the process proceeds to step S557. In step S561, the MCU 33 assigns 1101h to the fourth kick flag YF, and then returns. The assigned value 1101h indicates that the above first pattern kick is performed with the left foot.

In step S557, the MCU 33 determines whether or not the flag LRF[1] is 10h, the process proceeds to step S559 if it is 10h, otherwise the process proceeds to step S563. In step S559, the MCU 33 assigns 1110h to the fourth kick flag YF, and then returns. The assigned value 1110h indicates that the above first pattern kick is performed with the right foot.

In step S563, the MCU 33 determines whether or not the variable F[1] is any one of 20h, 21h, 22h, and 23h, the process proceeds to step S565 if the positive determination, conversely the process proceeds to step S579 if the negative determination.

In step S565, the MCU 33 determines whether or not the previous value of the variable F[1] is anyone of 10h, 11h, and 12h, the process proceeds to step S567 if the positive determination, conversely the process proceeds to step S575 if the negative determination. In step S567, the MCU 33 determines whether or not the previous right-left flag LRF[1] is 01h, the process proceeds to step S569 if it is 01h, otherwise the process proceeds to step S571. In step S569, the MCU 33 assigns 2210h to the fourth kick flag YF, and then returns. The assigned value 2210h indicates that the above second pattern kick is performed with the right foot.

In step S571, the MCU 33 determines whether or not the previous flag LRF[1] is 10h, the process proceeds to step S573 if it is 10h, otherwise the process proceeds to step S579. In step S573, the MCU 33 assigns 2201h to the fourth kick flag YF, and then returns.

The assigned value 2201h indicates that the above second pattern kick is performed with the left foot.

In step S575, the MCU 33 determines whether or not the previous flag LRF[1] is 00h, the process proceeds to step S577 if it is 00h, otherwise the process proceeds to step S579. In step S577, the MCU 33 assigns 3311h to the fourth kick flag YF, and then returns.

The assigned value 3311h indicates that the above third pattern kick is performed.

In step S579, the MCU 33 determines whether or not the variable F[2] is any one of 20h, 21h, 22h, and 23h, the process proceeds to step S581 if the positive determination, conversely the process proceeds to step S591 if the negative determination.

In step S581, the MCU 33 determines whether or not the previous value of the variable F[2] is anyone of 10h, 11h, and 12h, the process proceeds to step S583 if the positive determination, conversely the process proceeds to step S591 if the negative determination. In step S583, the MCU 33 determines whether or not the previous right-left flag LRF[2] is 01h, the process proceeds to step S585 if it is 01h, otherwise the process proceeds to step S587. In step S585, the MCU 33 assigns 4410h to the fourth kick flag YF, and then returns. The assigned value 4410h indicates that the above fourth pattern kick is performed with the right foot.

In step S587, the MCU 33 determines whether or not the previous flag LRF[2] is 10h, the process proceeds to step S589 if it is 10h, otherwise the process proceeds to step S591. In step S589, the MCU 33 assigns 4401h to the fourth kick flag YF, and then returns.

The assigned value 4401h indicates that the above fourth pattern kick is performed with the left foot.

In step S591, the MCU 33 assigns 0000h to the fourth kick flag YF, and then proceeds to step S215 of FIG. 12. The assigned value 0000h indicates that the player 25 does not kick.

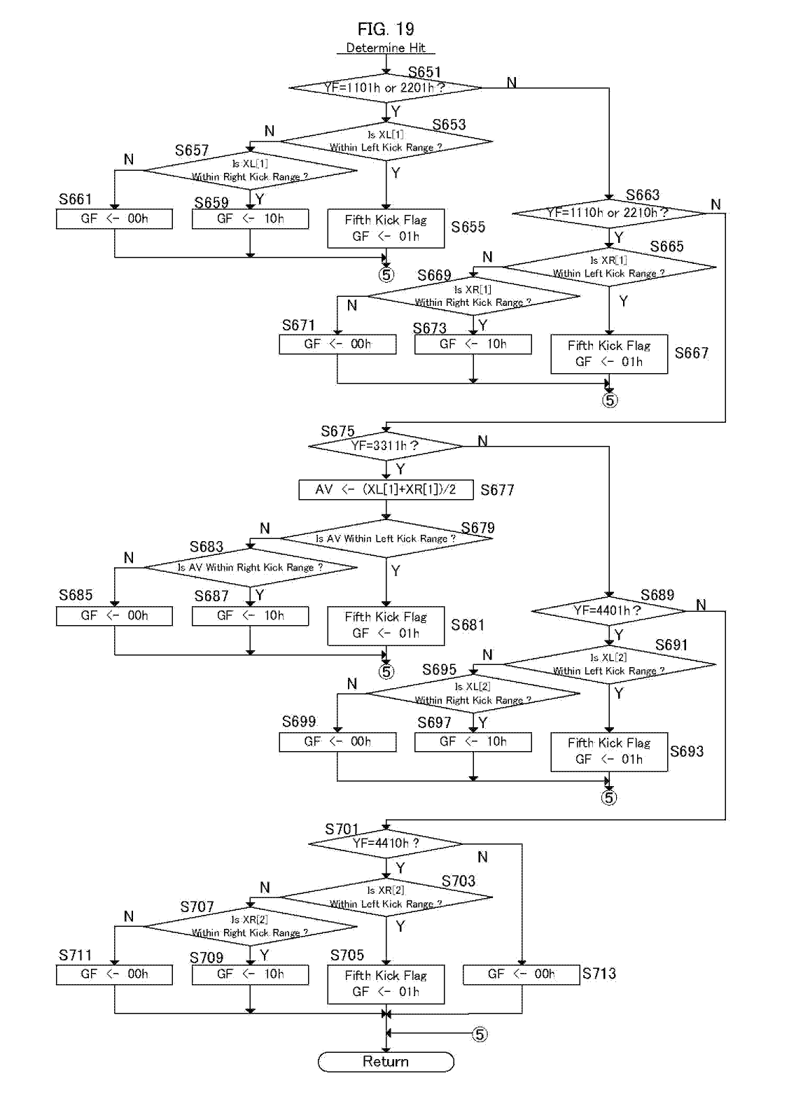

FIG. 19 is a flow chart for showing an example of the hit determining process in the step S213 of FIG. 13. Referring to FIG. 19, in step S651, the MCU 33 determines whether or not the fourth kick flag YF is either 1101h or 2201h, the process proceeds to step S653 if the positive determination, conversely the process proceeds to step S663 if the negative determination. In step S653, the MCU 33 determines whether or not the value of the variable XL[1] is within the left kick range, the process proceeds to step S655 if it is within the range, conversely the process proceeds to step S657 if it is out of the range. In step S655, the MCU 33 assigns 01h to the fifth kick flag GF, and then returns. The assigned value 01h indicates that the left ball 81LP is kicked.

In step S657, the MCU 33 determines whether or not the value of the variable XL[1] is within the right kick range, the process proceeds to step S659 if it is within the range, conversely the process proceeds to step S661 if it is out of the range. In step S659, the MCU 33 assigns 10h to the fifth kick flag GF, and then returns. The assigned value 10h indicates that the right ball 81RP is kicked.

Also, in step S661, the MCU 33 assigns 00h to the fifth kick flag GF, and then returns. The assigned value 00h indicates an air shot.

In step S663, the MCU 33 determines whether or not the fourth kick flag YF is either 1110h or 2210h, the process proceeds to step S665 if the positive determination, conversely the process proceeds to step S675 if the negative determination. In step S665, the MCU 33 determines whether or not the value of the variable XR[1] is within the left kick range, the process proceeds to step S667 if it is within the range, conversely the process proceeds to step S669 if it is out of the range.

In step S667, the MCU 33 assigns 01h to the fifth kick flag GF, and then returns. In step S669, the MCU 33 determines whether or not the value of the variable XR[1] is within the right kick range, the process proceeds to step S673 if it is within the range, conversely the process proceeds to step S671 if it is out of the range. In step S673, the MCU 33 assigns 10h to the fifth kick flag GF, and then returns. Also, in step S671, the MCU 33 assigns 00h to the fifth kick flag GF, and then returns.

In step S675, the MCU 33 determines whether or not the fourth kick flag YF is 3311h, the process proceeds to step S677 if it is 3311h, otherwise the process proceeds to step S689. In step S677, the MCU 33 assigns the value obtained by the following formula to the variable AV.

AV<-(XL[1]+XR[1])/2

In step S679, the MCU 33 determines whether or not the value of the variable AV is within the left kick range, the process proceeds to step S681 if it is within the range, conversely the process proceeds to step S683 if it is out of the range.

In step S681, the MCU 33 assigns 01h to the fifth kick flag GF, and then returns. In step S683, the MCU 33 determines whether or not the value of the variable AV is within the right kick range, the process proceeds to step S687 if it is within the range, conversely the process proceeds to step S685 if it is out of the range. In step S687, the MCU 33 assigns 10h to the fifth kick flag GF, and then returns. Also, in step S685, the MCU 33 assigns 00h to the fifth kick flag GF, and then returns.

In step S689, the MCU 33 determines whether or not the fourth kick flag YF is 4401h, the process proceeds to step S691 if it is 4401h, otherwise the process proceeds to step S701. In step S691, the MCU 33 determines whether or not the value of the variable XL[2] is within the left kick range, the process proceeds to step S693 if it is within the range, conversely the process proceeds to step S695 if it is out of the range.

In step S693, the MCU 33 assigns 01h to the fifth kick flag GF, and then returns. In step S695, the MCU 33 determines whether or not the value of the variable XL [2] is within the right kick range, the process proceeds to step S697 if it is within the range, conversely the process proceeds to step S699 if it is out of the range. In step S697, the MCU 33 assigns 10h to the fifth kick flag GF, and then returns. Also, in step S699, the MCU 33 assigns 00h to the fifth kick flag GF, and then returns.

In step S701, the MCU 33 determines whether or not the fourth kick flag YF is 4410h, the process proceeds to step S703 if it is 4410h, otherwise the process proceeds to step S713. In step S703, the MCU 33 determines whether or not the value of the variable XR[2] is within the left kick range, the process proceeds to step S705 if it is within the range, conversely the process proceeds to step S707 if it is out of the range.

In step S705, the MCU 33 assigns 01h to the fifth kick flag GF, and then returns. In step S707, the MCU 33 determines whether or not the value of the variable XR[2] is within the right kick range, the process proceeds to step S709 if it is within the range, conversely the process proceeds to step S711 if it is out of the range. In step S709, the MCU 33 assigns 10h to the fifth kick flag GF, and then returns. Also, in step S711, the MCU 33 assigns 00h to the fifth kick flag GF, and then returns.

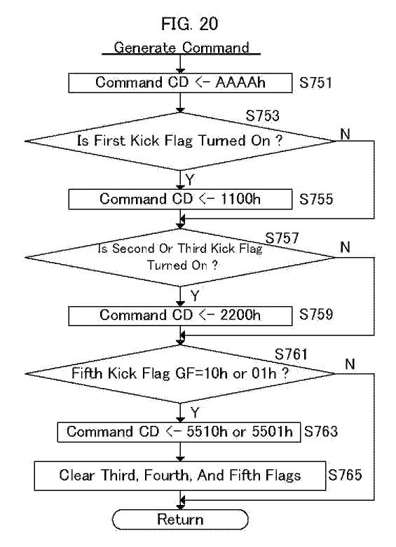

FIG. 20 is a flow chart for showing an example of the command generating process in the step S215 of FIG. 13. Referring to FIG. 20, in step S751, the MCU 33 sets a command CD to AAAAh. The set value AAAAh indicates that all of the first to fifth kick flags are turned off.

In step S753, the MCU 33 determines whether or not the first kick flag is turned on, the process proceeds to step S755 if it is turned on, conversely the process proceeds to step S757 if it is turned off. In step S755, the MCU 33 sets the command CD to 1100h which indicates that the first kick flag is turned on.

In step S757, the MCU 33 determines whether or not either the second kick flag or the third kick flag is turned on, the process proceeds to step S759 if it is turned on, conversely the process proceeds to step S761 if it is turned off. In step S759, the MCU 33 sets the command CD to 2200h which indicates that either the second kick flag or the third kick flag is turned on.

In step S761, the MCU 33 determines whether or not the fifth kick flag GF is either 10h or 01h, the process proceeds to step S763 if the positive determination, conversely the process returns if the negative determination. In step S763, if the fifth kick flag GF is 10h, the MCU 33 sets the command CD to 5510h which indicates that the right ball 81RP is kicked. Also, if the fifth kick flag GF is 01h, the MCU 33 sets the command CD to 5501h which indicates that the left ball 81LP is kicked.

In step S765, the MCU 33 clears the third kick flag, the fourth kick flag YF, and the fifth kick flag GF, and then returns.

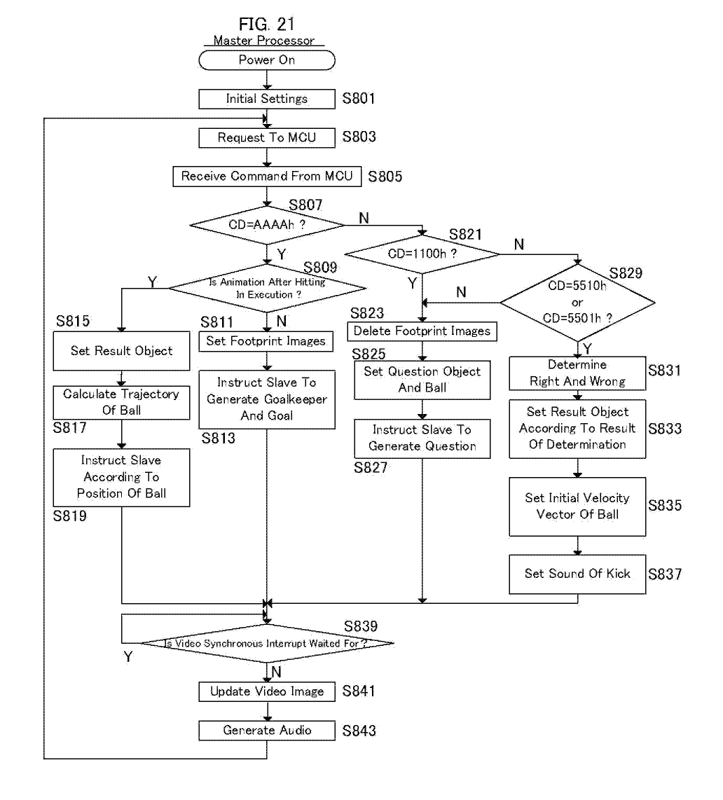

FIG. 21 is a flow chart for showing an example of the processing by the master processor 41 of FIG. 2. Referring to FIG. 21, in step S801, the master processor 41 performs initial settings. In step s803, the master processor 41 transmits the request signal to the MCU 33. In step S805, the master processor 41 receives the command CD from the MCU 33 which responds to the request signal. In step S807, the master processor 41 determines whether or not the command CD indicates AAAAh, the process proceeds to step S809 if AAAAh, otherwise the process proceeds to step S821.

In step S809, the master processor 41 determines whether or not animation after hitting is in execution, the process proceeds to step S815 if it is in execution, otherwise the process proceeds to step S811. The animation after hitting is animation in which the ball moves toward the goal object 75 by determining that either the ball 81LP or 81RP is kicked, and it is caught by the goalkeeper object 73 or it goes into the goal object 75.

In step S811, the master processor 41 sets two footprint images so that the footprint images are projected on the retroreflective sheets 19-1 and 19-2 respectively. In step S813, the master processor 41 instructs the slave processor 45 to generate the goalkeeper object 73 and the goal object 75.

Incidentally, in the case where the command CD indicates AAAAh and the animation after hitting is not in execution, the case indicates that the animation after hitting is finished and the state is the preparation state of the next play. Or, this case indicates that the state is the preparation state of the first play. Thus, the footprint images are projected on the retroreflective sheets 19-1 and 19-2 so as to prompt the player 25 to perform the next play or the first play.

In step S821, the master processor 41 determines whether or not the command CD indicates 1100h, the process proceeds to step S823 if it is 1100h, otherwise the process proceeds to step S829. In step S823, the master processor 41 deletes the footprint images. In step S825, the master processor 41 sets the question objects 79L and 79R, and the ball objects 81LP and 81RP. In step S827, the master processor 41 gives the question to be displayed on the question area 77 to the slave processor 45.

Incidentally, in the case where the positive determination is made in step S821, the case indicates that the first kick flag is turned on and the player completes the preparation of the play.

In step S829, the master processor 41 determines whether or not the command CD indicates either 5510h or 5501h, the process proceeds to step S831 if the positive determination, conversely the process proceeds to step S823 if the negative determination. Since the player 25 kicks neither the ball object 81LP nor 81RP yet, the process proceeds to step S823.

In step S831, the master processor 41 determines whether or not the answer of the player is correct in accordance with the value set to the command CD. In step S833, the master processor 41 sets the result object 83 based on the result or the determination. In step S835, the master processor 41 sets the initial velocity vector of the ball object. In step S837, the master processor 41 sets the sound of the kick.

Also, when the animation after hitting is in execution, in step S815, the master processor 41 continuously sets the result object 83 of step S833. In step S817, the master processor 41 calculates and sets a trajectory of the ball object 81LP or 81RP as kicked. In step S819, the master processor 41 instructs the slave processor 45 in accordance with the location of the ball object. That is, the master processor 41 sends the coordinates and velocity vector to the slave processor 45 so that the trajectory of the ball object in the screen 71P is smoothly linked to the trajectory of the ball object in the screen 71T.

By the way, in step S839, the master processor 41 determines whether or not a state thereof is a state of waiting for an interrupt by a video system synchronous signal, the process returns to step S839 if the state is the state of waiting for the interrupt, conversely the process proceeds to step S841 if the state is not the state of waiting for the interrupt, i.e., the interrupt by the video system synchronous signal is given. The master processor 41 generates the video signal VD1 based on the settings (steps S811, S815, S817, S823, S825, S833, and S835) to update the screen 71P in step S841, generates the audio signal AU1 based on the settings (S837) in step S843, and then returns to step S803.

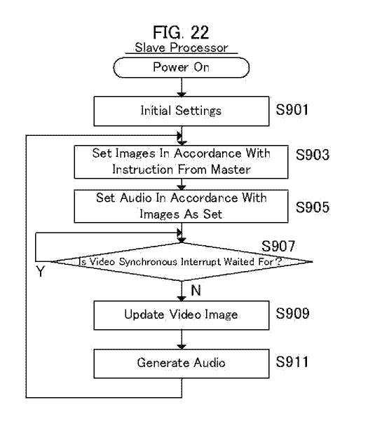

FIG. 22 is a flow chart for showing an example of the processing by the slave processor 45 of FIG. 2. Referring to FIG. 22, in step S901, the slave processor 45 performs initial settings. In step S903, the slave processor 45 sets the images based on the instructions from the master processor 41 (steps S813, S819, and S827 of FIG. 21). In step S905, the slave processor 45 sets the sound based on the images as set in step S903. In step S907, the slave processor 45 determines whether or not a state thereof is a state of waiting for an interrupt by a video system synchronous signal, the process returns to step S907 if the state is the state of waiting for the interrupt, conversely the process proceeds to step S909 if the state is not the state of waiting for the interrupt, i.e., the interrupt by the video system synchronous signal is given. The slave processor 45 generates the video signal VD2 based on the settings (step S903) to update the screen 71T in step S909, generates the audio signal AU2 based on the settings (step S905) in step S911, and then returns to step S903.

By the way, as described above, in accordance with the present embodiment, the retroreflective sheets 17-1 to 17-3, 19-1, and 19-2 attached on the stationary member (in the above example, the screen 15) are photographed, and then the shade areas corresponding to the feet of the player are detected from the differential picture. The detection of the shade areas corresponds to the detection of the feet of the player 25. Because, in the case where the foot is placed on the retroreflective sheet (the case includes a case where the foot is positioned just over the retroreflective sheet when the foot passes over the retroreflective sheet), the part corresponding thereto is not captured in the differential picture, and is present as a shade area. In this way, it is possible to detect the foot of the player 25 by photographing without making the player 25 wear the retroreflective sheet and attaching the retroreflective sheet to the player 15.

Also, it is possible to detect the movement of the foot by detecting the movement of the shade area in the differential picture. Because, in the case where the foot moves from one position on a retroreflective sheet to other position on the retroreflective sheet, the shade area also moves from a position on the picture corresponding the one position to a position on the picture corresponding the other position, or in the case where the foot moves from one retroreflective sheet to other retroreflective sheet, the shade area also moves from an image of the one retroreflective sheet to an image of the other retroreflective sheet.

In particular, in the present embodiment, the retroreflective sheets 17-1 to 17-3 have a beltlike shape. Thus, it is possible to detect the movement of the foot in a longitudinal direction of the retroreflective sheet (in the X direction of the differential picture). Also, a plurality of the retroreflective sheets 17-1 to 17-3 are arranged in a manner parallel to one another. Thus, it is possible to detect the movement of the foot in a direction perpendicular to the longitudinal direction of the retroreflective sheet (in the Y direction of the differential picture).

Also, in the present embodiment, as the distance to the image sensor 31 more increases, the widths of the retroreflective sheets 17-1 to 17-3 in a thickness direction are wider. Thus, even the image sensor 31 of relatively low-resolution is employed, it is possible to prevent a problem that it is not possible to recognize (capture) the image of the retroreflective sheet (e.g., 17-3) being arranged at a position where a distance to the image sensor 31 is larger.

Further, as the distance to the image sensor 31 more increases, spacings between the retroreflective sheets 17-1 to 17-3 more increase. Thus, even the image sensor 31 of relatively low-resolution is employed, it is possible to prevent a problem that it is not possible to discriminate the images of the two retroreflective sheets (e.g., 17-2 and 17-3) being arranged at positions where distance to the image sensor 31 is larger.

Also, in the present embodiment, the retroreflective sheets 19-1 and 19-2 for inputting the command to the controller 3 by the player 25 are disposed. Thus, the player 25 can input the command by covering the retroreflective sheets 19-1 and 19-2. Because it is considered that the command is inputted when it is detected on the differential picture that the retroreflective sheets 19-1 and 19-2 are covered.

Further, in the present embodiment, the retroreflective sheets 17-1 to 17-3, 19-1, and 19-2 are fixed on the flat screen 15. Thus, it is possible to easily attach and certainly fix the retroreflective sheets. Also, it is possible to reduce the processing to the retroreflective sheets. Further, the screen 15 on which the retroreflective sheets 17-1 to 17-3, 19-1, and 19-2 are fixed is placed on the floor face or is just the floor face. Thus, it is suitable for detecting the position and movement of the foot of the player 25, i.e., performing the input by moving the foot.

Further, in the present embodiment, the infrared light emitting diodes 23 irradiate the retroreflective sheets 17-1 to 17-3, 19-1, and 19-2 with the infrared light. Thus, since the retroreflective sheets reflect the irradiated light, the retroreflective sheets are more clearly reflected on the differential picture, and thereby it is possible to detect the shade area more accurately. Also, since the retroreflective sheets 17-1 to 17-3, 19-1, and 19-2 reflect the irradiated light retroreflectively, it is possible to more certainly input the reflected light from the retroreflective sheets to the image sensor 31 by arranging the infrared light emitting diodes 23 and the image sensor 31 in nearly the same positions. Further, the infrared light emitting diodes 23 intermittently irradiate with the infrared light while the MCU 33 detects the shade area from the differential picture between the picture at the light emitting time and the picture at the non-light emitting time. In this way, it is possible to eliminate, as much as possible, noise of light other than the light reflected from the retroreflective sheets by the simple process of obtaining the difference, and thereby only the images of the retroreflective sheets can be detected with a high degree of accuracy. To detect the images of the retroreflective sheets with a high degree of accuracy means that it is possible to detect the shade area with a high degree of accuracy. Still further, it is possible to easily eliminate the noise other than the infrared light by irradiating with the infrared light and photographing through the infrared ray filter 21.

In addition, in accordance with the present embodiment, it is possible to show the information to the player 25 (a kind of object) by the video image, detect the player 25 moving according to the showing, and generate the video image based on the result of detecting. That is, it is possible to establish the interactive system. In this case, the motion of the player 25 is detected by the novel means (method) as described above. Consequently, it is possible to establish the interactive system using this novel means. Incidentally, in the aspect of the player 25, to be detected represents to carry out the input.

Also, in the present embodiment, the plurality of the video images (in the above case, the screens 71P and 71T) is generated so as to display on the plurality of the screens (in the above case, the screen 15 and the television monitor 5). In this way, since it is possible to simultaneously display the plurality of the video images on the plurality of the screens, entertainment properties can be enhanced. In this case, the plurality of the video images to be displayed on the plurality of the screens is coordinated with each other (in the above example, the trajectories of the ball objects as kicked are smoothly linked to each other between the screens 71P and 71T). As the result, it is possible to enhance realistic sensation. Also, the screen 71P is projected on the horizontal screen 15 while the screen 71T is displayed on the vertical television monitor 5. As the result, the player 25 (a kind of object) can move the body to input while viewing both of the video image projected on the horizontal plane and the video image displayed on the vertical plane.

Meanwhile, the present invention is not limited to the above embodiments, and a variety of variations and modifications may be effected without departing from the spirit and scope thereof, as described in the following exemplary modifications.

(1) A plurality of retroreflective sheets (e.g., circular shapes) which is two-dimensionally (in a reticular pattern) arranged may be fixed on the screen 15 in place of or in addition to the retroreflective sheets 17-1 to 17-3. Needless to add, the respective retroreflective sheets may have any shape. In this case, it is possible to detect the position and the movement of the player (the object) in the two-dimensional direction.

Also, retroreflective sheets (e.g., circular shapes) which are one-dimensionally arranged may be fixed on the screen 15 in place of or in addition to the retroreflective sheets 17-1 to 17-3. Needless to add, the respective retroreflective sheets may have any shape. In this case, it is possible to detect the position and the movement of the player (the object) in the one-dimensional direction.

Further, a single and large retroreflective sheet (e.g., rectangular shape) may be fixed on the screen 15 in place of or in addition to the retroreflective sheets 17-1 to 17-3. Needless to add, the respective retroreflective sheet may have any shape.

(2) It is preferable that the distances L1 and L2 are set so that the distance between the image of the retroreflective sheet 17-2 and the image of the retroreflective sheet 17-3 on the differential picture is equal to the distance between the image of the retroreflective sheet 17-1 and the image of the retroreflective sheet 17-2 on the differential picture.

Also, the widths d1, d2 and d3 may be set so that the width of the image of the retroreflective sheet 17-1, the width of the image of the retroreflective sheet 17-2, and the width of the image of the retroreflective sheet 17-3 on the differential picture are equal to one another on the differential picture.

(3) In the above embodiment, the example in which the object detecting apparatus is applied to the interactive system 1 is cited. However, an example of the application thereof is not limited to this. Also, in the above embodiment, although the two screens 71P and 71T are displayed on the two screens 15 and 5, either of them may be used. Further, although the video image is projected on the screen 15 by using the projector 9, instead, a television monitor may be embedded in the floor. Conversely, a projector may project the screen 71T in place of the television monitor 5. Also, a display device is not limited to a projector and a television monitor, and may be optional. In the above embodiment, although the object detecting apparatus is combined with the devices which supply with the video images, an object to be combined is not limited to them.

(4) In the above embodiment, although the foot of the player 25 is detected, an object to be detected is not limited to the foot, and may be the other thing other than an animal (in the above embodiment, a human). Also, although the retroreflective sheets are fixed on the horizontal plane, the retroreflective sheets may be fixed, in accordance with the object, on the vertical plane, or, on each of the horizontal plane and the vertical plane, The number of the retroreflective sheets 17-1 to 17-3 is not limited to three, the number thereof may be the number other than three. This point is true regarding the retroreflective sheets 19-1 and 19-2.

(5) In the above embodiment, although the MCU 33 performs the image analysis, the master processor 41 may receive the differential picture to analyze it. Also, in the above embodiment, although the various processes are executed after binarizing the differential picture, the various processes may be executed while binarizing. Further, in the above embodiment, though the shade area, i.e., only the coordinates of the foot are acquired, the movement of the coordinates of the foot, i.e., the velocity of the foot may be detected and calculated. Needless to add, the acceleration of the foot may be detected and calculated.

(6) Contents are not limited to the contents shown in FIGS. 6A, 6B, 7A, and 7B. Arbitrary contents may be created. In the above embodiment, although the game in the aspect of the intellectual training is provided, a pure game may be provided, or games in fields of education and sports, and in the other various fields may be provided. Also, images and computer programs which execute contents may be delivered by a removable media such as a memory cartridge, CD-ROM, or the like. Further, these may be delivered through a network such as Internet.

(7) In the above embodiment, if either the top-left shade area or the top-right shade area is within any one of the left hit range and the right hit range, it is determined that the motion of kicking the ball object has been performed. However, the determination of the hit is not limited to this. For example, when an average value between the X coordinate of the top-left shade are and the X coordinate of the top-right shade area is within any one of the left hit range and the right hit range, it may be determined that the motion of kicking the ball object has been performed. Also, for example, when the X coordinate of the top shade area corresponding to the foot which performs the kick motion is within any one of the left hit range and the right hit range, it may be determined that the motion of kicking the ball object has been performed.

(8) A light-emitting device such as an infrared light emitting diode may be embedded in the screen 15 instead of attaching the retroreflective sheets on the screen 15. In this case, it is not necessary for the imaging unit 7 to have the infrared light emitting diodes 23. Also, an imaging device is not limited to the image sensor, and therefore another imaging device such as CCD may be employed.

(9) Although the above stroboscope imaging (the blinking of the infrared light emitting diodes 23) and the differential processing are cited as the preferable example, these are not elements essential for the present invention. That is, the infrared light emitting diodes 23 do not have to blink, or there may be no need of the infrared light emitting diodes 23. Light to be emitted is not limited to the infrared light.

(10) In the above embodiment, the retroreflective sheets 17-1 to 17-3, 19-1, and 19-2 are trodden by the player 25, and therefore it is possible to improve durability by covering them with a transparent or semitransparent member (e.g., a thin board such as polycarbonate and acryl, or a sheet or film such as polyester) in order to protect. Also, the retroreflective sheet may be coated with transparent or semitransparent material. Needless to say, the whole screen 15 on which the retroreflective sheets are fixed may be protected by them.

(11) In the above embodiment, the retroreflective sheet is fixed on the screen 15. However, it is a preferable example, a reflective member which does not reflect light retroreflectively may be employed (e.g., a member with diffuse reflection property, or a member with specular reflection property).

(12) In the above embodiment, the MCU 33, the master processor 41, and the slave processor 45 are employed as an arithmetic unit. However, it is an example, a single computer may perform the overall processing. That is, it may be optionally determined which arithmetic unit performs which process.

(13) Information to be transmit from the MCU 33 to the master processor 41 is not limited to the above information, and therefore it may be optionally set based on specification.

(14) The shade area emerges in any one of the case where the foot is placed on the retroreflective sheet, the case where the foot is positioned just over the retroreflective sheet while the foot is not placed on the retroreflective sheet, and the case where the retroreflective sheet is shaded by the foot. Accordingly, in the above embodiment, even all of them are not cited as a cause of the emergence of the shade area, the shade area means that any one of these cases has occurred.

The present invention is available in a field of entertainment such as a video game, a field of education, and so on.

While the present invention has been described in terms of embodiments, those skilled in the art will recognize that the invention is not limited to the embodiments described. The present invention can be practiced with modification and alteration within the spirit and scope of the appended claims. The description is thus to be regarded as illustrative instead of limiting in any way on the present invention.

What is claimed is:

1. An object detecting device apparatus for detecting an object in real space, comprising:
a reflective member that is attached to a stationary member, and reflects received light;
an imaging unit configured to photograph the reflective member; and
an analyzing unit configured to analyze a picture obtained by photographing,
wherein the analyzing unit comprising:
a detecting unit configured to detect, from the picture, a shade area corresponding to a part of the reflective member which is covered by the object.

2. The object detecting apparatus as claimed in claim 1 wherein the reflective member has a beltlike shape.

3. The object detecting apparatus as claimed in claim 1 wherein a plurality of the reflective members is attached to the stationary member,
wherein each of the reflective members has a beltlike shape, and
wherein the plurality of the reflective members are arranged on the stationary member in a manner parallel to each other.

4. The object detecting apparatus as claimed in claim 3 wherein as a distance to the imaging unit more increases, widths of the reflective members in a thickness direction are wider.

5. The object detecting apparatus as claimed in claim 3 wherein as a distance to the imaging unit more increases, spacing between the reflective members more increases.

6. The object detecting apparatus as claimed in claim 1 wherein a plurality of the reflective members is attached to the stationary member.

7. The object detecting apparatus as claimed in claim 6 wherein at least a predetermined number of reflective members of the plurality of the reflective members are two-dimensionally arranged.

8. The object detecting apparatus as claimed in claim 6 wherein at least a predetermined number of reflective members of the plurality of the reflective members are one-dimensionally arranged.

9. The object detecting apparatus as claimed in claim 6 wherein the plurality of the reflective members includes a reflective member for inputting a predetermined command to a computer by a user.

10. The object detecting apparatus as claimed in claim 1 wherein the stationary member contains a horizontal plane,
wherein the reflective member is attached to the horizontal plane.

11. The object detecting apparatus as claimed in claim 10 wherein the stationary member is placed on a floor face or is just a floor face.

12. The object detecting apparatus as claimed in claim 1 further comprising:
an irradiating unit configured to emit light to irradiate the reflective member with the light.

13. The object detecting apparatus as claimed in claim 12 wherein the reflective member retroreflectively reflects the received light.

14. The object detecting apparatus as claimed in claim 13 wherein the irradiating unit intermittently emits the light to irradiate the reflective member with the light,
wherein the detecting unit detects the shade area from a differential picture between a picture obtained by photographing when the light is emitted and a picture obtained by photographing when the light is not emitted.

15. The object detecting apparatus as claimed in claim 12 wherein the irradiating unit emits infrared light,
wherein the imaging unit photographs the reflective member via an infrared light filter through which only infrared light passes.

16. The object detecting apparatus as claimed in claim 1 further comprising:
a transparent or semitransparent member that covers the reflective member at least.

17. An interactive system comprising:
an object detecting unit configured to detect an object in real space; and
an information processing unit configured to perform information processing based on result of detection by the object detecting unit,
wherein the object detecting unit comprising:
a reflective member that is attached to a stationary member, and reflects received light;
an imaging unit configured to photograph the reflective member; and
an analyzing unit configured to analyze a picture obtained by photographing,
wherein the analyzing unit comprising:
a detecting unit configured to detect, from the picture, a shade area corresponding to a part of the reflective member which is covered by the object,
wherein the information processing unit comprising:
an image generating unit configured to generate an image based on the result of the detection by the detecting unit.

18. The interactive system as claimed in claim 17 wherein the image generating unit generates a plurality of the images in order to display on a plurality of screens.

19. The interactive system as claimed in claim 18 wherein the image generating unit coordinates the plurality of the images displayed on the plurality of the screens.

20. The interactive system as claimed in claim 18 wherein the image generating unit comprising:
a unit configured to display a first image of the plurality of the images on a horizontal plane; and
a unit configured to display a second image of the plurality of the images on a vertical plane.

21. The interactive system as claimed in claim 20 wherein the stationary member contains a horizontal plane,
wherein the reflective member is attached to the horizontal plane.

22. The interactive system as claimed in claim 21 wherein the stationary member is placed on a floor face or is just a floor face.

23. An object detecting method for detecting an object in a real space using a reflective member which is attached to a stationary member and reflects received light, comprising the steps of:
photographing the reflective member; and
analyzing a picture obtained by photographing,
wherein the step of analyzing comprising:
detecting, from the picture, a shade area corresponding to a part of the reflective member which is covered by the object.

24. A method for establishing an interactive system, comprising the steps of:
detecting an object in a real space using a reflective member which is attached to a stationary member and reflects received light; and
performing information processing based on result of detection by the step of detecting,
wherein the step of detecting comprising:
photographing the reflective member; and
analyzing a picture obtained by photographing,
wherein the step of analyzing comprising:
detecting, from the picture, a shade area corresponding to a part of the reflective member which is covered by the object,
wherein the step of performing the information processing comprising:
generating an image based on result of detection by the step of detecting the shade area.

25. A computer-readable medium storing a computer program that enables a computer to perform an object detecting method of claim 23.

26. A computer-readable medium storing a computer program that enables a computer to perform a method for establishing an interactive system of claim 24.
